(19) United States
(12) Patent Application Publication
(10) Pub. No.: US 2005/0002704 A1
(43) Pub. Date: Jan. 6, 2005

(54) Image forming process, image forming apparatus and electrophotographic print

(75) Inventors: Yoshisada Nakamura, Shizuoka (JP); Ashita Murai, Shizuoka (JP); Masataka Murata, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/879,593

(22) Filed: Jun. 30, 2004

(30) Foreign Application Priority Data
Jul. 1, 2003 (JP) 2003-189566

(51) Int. Cl. G03G 15/20

(52) U.S. Cl. 399/341

(57) ABSTRACT

The image forming process according to the present invention comprises forming a toner image on an electrophotographic image receiving sheet, wherein the electrophotographic image receiving sheet comprises a support and a toner image receiving layer, the toner image receiving layer comprises a thermoplastic resin, and the toner image receiving layer is formed on at least one surface of the support, and wherein in the electrophotographic image receiving sheet, a peripheral margin exists on which the toner image is not formed, and the width of the peripheral margin is 1.2 mm to 13 mm.

### BACKGROUND OF THE INVENTION

1. Field of the Invention

The present invention relates to an image forming process, which may efficiently produce electrophotographic prints in which images are formed on their entire surface, in other words such electrophotographic prints that do not possess or bear peripheral margins as well as image turbulences at the peripheral region in particular, without causing stains or smears on electrophotographic image receiving sheets and related apparatuses or devices. The present invention also relates to an image forming apparatus and electrophotographic prints.

2. Description of the Related Art

In the electrophotographic technology, it is difficult to print images without unprinted portions at the peripheral regions; usually peripheral margins exist in the electrophotographic prints. Accordingly, the peripheral unprinted portions must be cut and removed, in order to obtain electrophotographic prints without peripheral margins. Further, in the electrophotographic technology, if a toner image is formed on electrophotographic image receiving sheets without peripheral margins, the toner that extends over the electrophotographic image receiving sheets must be cleaned. Moreover, if the unfixed toner on the peripheral portions of the electrophotographic image receiving sheet attaches to a conveying member and the like, or if the toner migrates beyond the predetermined region at the fixing operation, such attached or migrated toner is very hard to be cleaned. Accordingly, it is apparent at present that the electrophotographic system that may provide electrophotographic prints without peripheral margins has not been realized yet.

In order to solve such problems, for example, an image recording sheet for producing prints without peripheral blank portions is proposed in which at least a recording layer is provided on one surface of support, and a peeling layer, tacky layer and removing sheet is laminated in order on the other surface of the support, wherein notches for peeling are provided on the image recording sheet of its recording side; when images are recorded on the portion encircled by the notches by means of an image recording unit, the images are recorded beyond the notches also, and the image recording sheet is peeled between the peeling layer and the tacky layer, thereby a print may be formed without peripheral blank portions (see Japanese Patent Application Laid-Open (JP-A) No. 2001-205936). In accordance with the proposal, electrophotographic prints may be produced without peripheral blank portions, while preventing the smearing of the apparatus and recording paper as well as avoiding the shortening of the apparatus life.

However, according to the proposal, such special recording paper with notches is required, and the recording paper is not versatile and is expensive.

As above discussed, electrophotographic prints that do not possess peripheral blank portions similarly to silver halide photographic prints, that do not smear the related apparatus or the electrophotographic image receiving sheet, and that do not possess or bear image turbulences at their periphery portions have not been easily and effectively produced.

### SUMMARY OF THE INVENTION

The object of the present invention is to provide an image forming process, which may efficiently produce electrophotographic prints which do not possess or bear peripheral margins as well as image turbulences at the peripheral region in particular similarly to silver halide photographic prints, without causing stains or smears on electrophotographic image receiving sheets and related apparatuses or devices, an image forming apparatus adapted to the image forming process, and an electrophotographic print provided by the image forming process that do not possess peripheral margins.

The image forming process according to the present invention comprises forming a toner image on an electrophotographic image receiving sheet,

wherein the electrophotographic image receiving sheet comprises a support and a toner image receiving layer, the toner image receiving layer comprises a thermoplastic resin, and the toner image receiving layer is formed on at least one surface of the support, and

wherein in the electrophotographic image receiving sheet, a peripheral margin exists on which the toner image is not formed, and the width of the peripheral margin is 1.2 mm to 13 mm.

In accordance with the present invention, the width of the peripheral margin, on which the toner image is not formed, is defined in a range from 1.2 mm to 13 mm. As the result, electrophotographic prints may be efficiently produced which do not possess or bear peripheral blank regions as well as image turbulences at the peripheral region in particular similarly to silver halide photographic prints, without causing stains or smears on electrophotographic image receiving sheets and related apparatuses or devices.

The image forming apparatus according to the present invention comprises an electrophotographic image receiving sheet and a toner image forming unit,

wherein the electrophotographic image receiving sheet comprises a support and a toner image receiving layer, the toner image receiving layer comprises a thermoplastic resin, and the toner image receiving layer is formed on at least one surface of the support,

wherein the toner image forming unit performs to form a toner image on the electrophotographic image receiving sheet, and

wherein in the electrophotographic image receiving sheet, a peripheral margin exists on which the toner image is not formed, and the width of the peripheral margin is 1.2 mm to 13 mm.

In accordance with the image forming apparatus, electrophotographic prints may be efficiently produced which do not possess or bear peripheral blank regions as well as image turbulences at the peripheral region similarly to silver halide photographic prints, without causing stains or smears on electrophotographic image receiving sheets and related apparatuses or devices.

The electrophotographic print according to the present invention may be provided through cutting and removing the peripheral margin, on which the toner image is not formed, of the electrophotographic print prepared by the image forming process according to the present invention, thereby the toner image is formed on the entire surface of the electrophotographic print.

As the result, electrophotographic prints with high quality that do not possess peripheral blank portions similarly to silver halide photographic prints may be produced easily and inexpensively.

### BRIEF DESCRIPTION OF THE DRAWINGS

FIG. 1 schematically shows an exemplary electrophotographic print, wherein the width of the region, on which the toner image is not formed, is relatively narrow.

FIG. 2 schematically shows an exemplary electrophotographic print, wherein the width of the region, on which the toner image is not formed, is relatively wide.

FIG. 3 schematically shows an exemplary electrophotographic print according to the present invention, wherein the peripheral margin, on which the toner image is not formed, is provided.

FIG. 4 schematically shows another exemplary electrophotographic print according to the present invention, wherein the peripheral margin, on which the toner image is not formed, is provided.

FIG. 5 schematically shows an exemplary image forming apparatus according to the present invention.

FIG. 6 schematically shows an exemplary unit for smoothening and fixing a toner image equipped in the image forming apparatus according to the present invention

### DESCRIPTION OF THE PREFERRED EMBODIMENTS

(Image Forming Process, Image Forming Apparatus and Electrophotographic Print)

The image forming process according to the present invention comprises forming a toner image, and also comprises cutting and removing the peripheral margin, smoothening and fixing the toner image, and others depending on the necessities.

The image forming apparatus according to the present invention comprises an electrophotographic image receiving sheet and a toner image forming unit, and also comprises a cutting and removing unit, a smoothening and fixing unit, and other units depending on the necessities.

The image forming process may be properly carried out by means of the image forming apparatus according to the present invention; the aforesaid cutting and removing the peripheral margin may be carried out by means of the aforesaid cutting and removing unit; the aforesaid smoothening and fixing the surface of the toner image may be carried out by means of the aforesaid smoothening and fixing unit; and others may be carried out by means of the other units.

The electrophotographic print according to the present invention may be produced through the image forming process according to the present invention.

The electrophotographic print according to the present invention will be realized in detail, with reference to the following discussion as to the image forming process and apparatus according to the present invention.

Image Forming

In the aforesaid forming a toner image, the toner image is formed on an electrophotographic image receiving sheet, which may be carried out by means of aforesaid image forming unit.

The image forming unit may be properly selected depending on the application; for example, the image forming unit comprises a latent electrostatic image bearing member, latent electrostatic image forming unit, developing unit, transferring unit, fixing unit, and other units properly selected depending on the necessities such as charge eliminating unit, cleaning unit, recycling unit and control unit.

In a condition that a toner image is formed on the electrophotographic image receiving sheet, the width of the peripheral margin on which the toner image is not formed is 1.2 mm to 13 mm, preferably 2 mm to 12 mm, more preferably 2 to 10 mm.

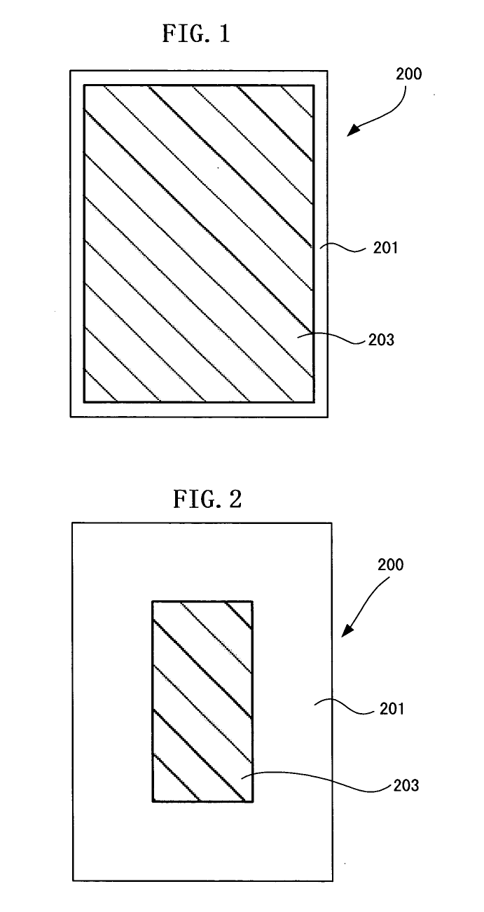

As shown in FIG. 1, when the width of the peripheral margin 201 on which the toner image is not formed is excessively narrow such as less than 1.2 mm, the toner image formation tends to be in disorder at the edge of toner image 203, and the image quality is likely to be inferior at the peripheral portion. Further, in the case that the electrophotographic image receiving sheet 200 comprises a toner image receiving layer that contains a thermoplastic resin, the thermoplastic resin extends beyond the predetermined region at the fixing step, thus the transferred toner image comes to be disturbed at the peripheral portion. Further, cleanings of the apparatus and the like may be often required similarly to at the preparation of electrophotographic prints without peripheral blank regions.

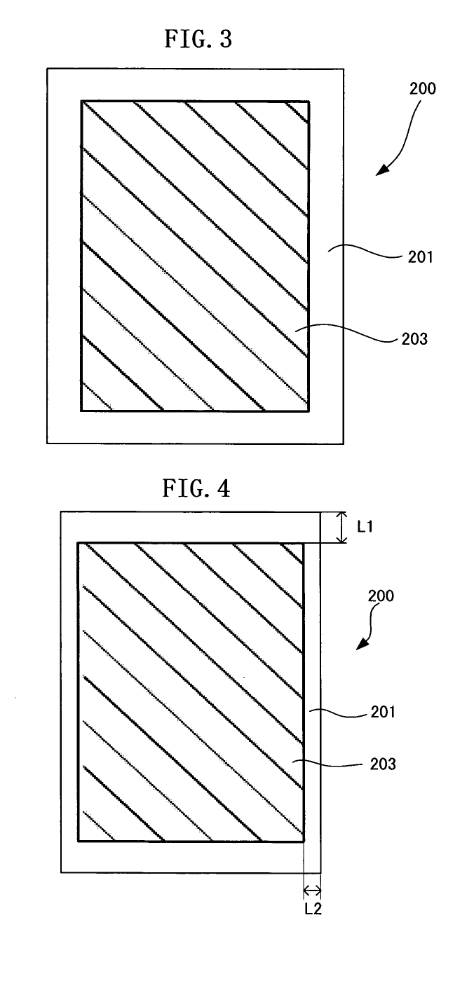

On the other hand, as shown in FIG. 2, when the width of the peripheral margin 201 on which the toner image is not formed is excessively wide such as more than 13 mm, the transferring member (e.g., intermediate transferring belt) may not sufficiently sustain the toner, therefore the contacting period with the electrophotographic image receiving sheet 200 comes to longer, and the transferring properties may be degraded at the leading portion of toner image 203. Further, the design of apparatus may become complicated due to difficult handling of the removed peripheral blank portions.

Preferably, the width of the peripheral margin 201 on which the toner image is not formed is substantially constant (identical width) in both of length and width directions of the electrophotographic image receiving sheet, because the width of the peripheral margin may be easily controlled.

Further, when the width of the peripheral margin 201, on which the toner image is not formed, is different between the length direction and the width direction of the electrophotographic image receiving sheet as shown in FIG. 4, preferably, the width of the peripheral margin on which the toner image is not formed in the length direction (L1) and the width of the peripheral margin on which the toner image is not formed in the width direction (L2) represent a relation of L1>L2. Owing to this relation, the image turbulence at the leading portion of the electrophotographic print may be prevented more efficiently. More preferably, the ratio of L1/L2 is more than one and less than two.

Preferably, the electrophotographic image receiving sheet is wrapped on a core material to form a roll configuration, from the stand points of convenience, storage, and productivity. Thereby, electrophotographic prints without peripheral blank regions may be produced efficiently with desired sizes. The sizes of the electrophotographic prints include, for example, L size (89 mm×127 mm), A6 size (105 mm×150 mm), A4 size (210 mm×300 mm), postcard size, name card size and the like.

Further, one or more of roll feeding unit, equipped with an electrophotographic image receiving sheet of roll configuration, may be provided in the image forming apparatus. In addition, a bundle of cut papers (electrophotographic image receiving sheets) contained in a sheet tray may be fed in place of or in combination with the roll configuration.

Cutting and Removing Peripheral Margin

In aforesaid cutting and removing the peripheral margin, electrophotographic prints may be produced through cutting and removing the peripheral margin, on which the toner image is not formed.

The cutting and removing unit may be properly selected depending on the applications; a circular cutter, guillotine cutter, rotary type cutter, and XY cutter may be exemplified.

Smoothening and Fixing Toner Image

In aforesaid smoothing and fixing a toner image, the surface of toner image is smoothened, following forming the toner image, which may be carried out by means of a smoothening and fixing unit.

As for the smoothening and fixing unit, such unit may be properly exemplified that smoothening and fixing the toner image is carried out through heating and pressing as well as cooling and peeling the toner image, by means of a smoothening and fixing unit that is equipped with a heating and pressing member, a belt member and a cooling device.

The heating and pressing member may be properly selected depending on the application; the fixing devices equipped in conventional electrophotographic apparatuses may be candidates, in particular, a pair of heating rollers, a combination of heating roller and pressing roller and like may be suitably exemplified.

The pair of heating rollers may be properly selected depending on the application, specifically, may be selected from the pair of heating rollers equipped in conventional electrophotographic apparatuses, preferably adjustable with respect to the nip pressure and heating temperature.

The heating and pressing member preferably performs heating at above the softening temperature of the thermoplastic resin compounded in at least one of the toner image receiving layer and the support; the operating temperature of the heating and pressing member may be properly selected depending on the application, preferably 50 to 120° C., more preferably 80 to 110° C. In the case that the thermoplastic resin is polyethylene resin, the operating temperature is preferably 95 to 105° C.

The belt member comprises a support film and a releasing layer arranged on the support film.

The support film is not particularly restricted, as long as being heat resistant, and may be properly selected depending on the application; examples of the film material include polyimide (PI), polyethylene naphthalate (PEN), polyethylene terephthalate (PET), polyether ether ketone (PEEK), polyether sulfone (PES), polyether imide (PEI), and poly(parabanic acid) (PPA).

The releasing layer is preferably comprised of the material selected from the group consisting of silicone rubbers, fluorocarbon rubbers, fluorocarbon siloxane rubbers, silicone resins, and fluorocarbon resins. Further, such configurations are preferred that a layer of fluorocarbon siloxane rubber is disposed on the belt member; alternatively a layer of silicone rubber is disposed on the surface of the belt member and a layer of fluorocarbon siloxane rubber is disposed on the layer of silicone rubber.

As for the fluorocarbon siloxane rubber, the type is preferred that has at least one of perfluoroalkyl ether group and perfluoroalkyl group in the backbone.

As for the fluorocarbon siloxane rubber, a cured product of fluorocarbon siloxane rubber composition which contains the following components of (A) to (D) is preferable: (A) fluorocarbon polymer having a fluorocarbon siloxane expressed by the following formula (1) as its main component, and containing aliphatic unsaturated groups, (B) organopolysiloxane and/or fluorocarbon siloxane containing two or more ≡SiH groups in one molecule, wherein the content of the ≡SiH groups is 1 to 4 times of the aliphatic unsaturated groups in the fluorocarbon siloxane rubber, (C) filler, and (D) effective amount of catalyst.

The fluorocarbon polymer of aforesaid component (A) comprises a fluorocarbon siloxane containing a repeated unit expressed by the following formula (1) as its main ingredient, and also contains aliphatic unsaturated groups.

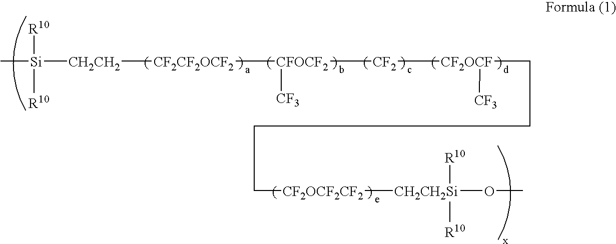

wherein, in the formula (1), R¹⁰ represents a non-substituted or substituted monofunctional hydrocarbon group containing preferably 1 to 8 carbon atoms, preferably an alkyl group containing 1 to 8 carbon atoms or an alkenyl group containing 2 to 3 carbon atoms, and particularly preferably a methyl group.

The “a” and “e” represent respectively an integer of 0 or 1. The “b” and “d” represent respectively an integer of 1 to 4. The “c” represents respectively an integer of 0 to 8. The “x” represents respectively an integer of 1 or more, preferably 10 to 30.

An example of such component (A) is a compound expressed by the following formula (2)

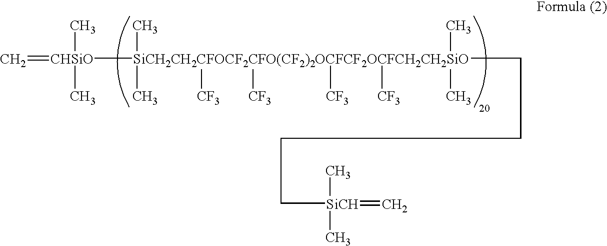

As for the component (B), an example of the organopolysiloxane comprising ≡SiH groups is organohydrogenpolysiloxane having at least two hydrogen atoms bonded to silicon atom in the molecule.

As for the fluorocarbon siloxane rubber composition, when the organocarbon polymer of component (A) comprises an aliphatic unsaturated group, the organohydrogenpolysiloxane may be preferably used as a curing agent. That is, the cured product is formed by an addition reaction between aliphatic unsaturated groups in the fluorocarbon siloxane, and hydrogen atoms bonded to silicon atoms in the organohydrogenpolysiloxane.

Examples of such organohydrogenpolysiloxane include the various organohydrogenpolysiloxanes used in an addition-curing type silicone rubber composition.

Preferably, the organohydrogenpolysiloxane is blended in such proportion that the number of “≡SiH groups” therein is at least one, and more preferably 1 to 5, relative to one aliphatic unsaturated hydrocarbon group in the fluorocarbon siloxane of component (A).

As for the fluorocarbon containing ≡SiH groups, R¹⁰ in the formula (1), as one unit or entire of the compound, is a dialkylhydrogensiloxane group, the terminal group is an ≡SiH group such as dialkylhydrogensiloxane group, silyl group and the like. An example of the fluorocarbon is that expressed by the following formula (3).

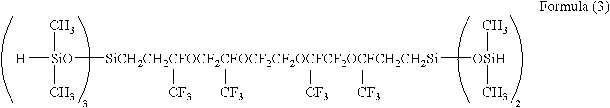

As for the filler of component (C), various fillers being utilized with conventional silicone rubbers may also be utilized. Examples of the filler include reinforcing fillers such as mist silica, precipitated silica, carbon powder, titanium dioxide, aluminum oxide, quartz powder, talc, sericite, bentonite and the like; and fiber fillers such as glass fiber, organic fibers and the like.

As for the catalyst of component (D), the catalysts known in the art as addition reaction catalyst may be exemplified such as chloroplatinic acid, alcohol-modified chloroplatinic acid, complexes of chloroplatinic acid and olefins, platinum black or palladium supported on a carrier as alumina, silica, carbon and the like, and Group VIII elements of the Periodic Table or compounds thereof such as complexes of rhodium and olefins, chlorotris(triphenylphosphine) rhodium (an Wilkinson catalyst), rhodium (III) acetyl acetonate and the like. These complexes are preferably utilized in a condition being dissolved in alcohol solvent, ether solvent, hydrocarbon solvent and the like.

The fluorocarbon siloxane rubber composition may be compounded various additives while maintaining the increased solvent resistance. For example, dispersing agents such as diphenylsilane diol, hydroxyl group terminated dimethylpolysiloxane of lower molecular weight, and hexamethyl disilazane; heat resistance improvers such as ferrous oxide, ferric oxide, cerium oxide, octyl acid iron, and the like; and colorants such as pigments or the like, may be compounded depending on the requirements.

The aforesaid belt member may be obtained by coating the surface of heat resistant support film with the fluorocarbon siloxane rubber composition, then heating and curing thereof. The composition may be diluted to form a coating solution with a solvent such as m-xylene hexafluoride, benzotrifluoride and the like. The temperature and period of the heating and curing may be suitably selected depending on the type of support film, process for manufacturing and the like, usually from the ranges of the 100° C. to 500° C. and 5 seconds to 5 hours.

A thickness of the releasing layer on the belt may be suitably selected; the thickness is preferably 1 to 200 μm, and more preferably 5 to 150 μm, so as to obtain good fixing properties for an image, and also to prevent the toner separation and offset of the toner components.

As for the way for fixing on the belt, JP-A No. 11-352819 discloses a way for fixing on an oilless type belt, JP-A No. 11-231671 and No. 05-341666 disclose a way for carrying out the secondary transfer and fixing simultaneously. An for an electrophotography apparatus comprising such fixing belt, such apparatus may be exemplified as comprising at least a heating and pressurizing part which may melt and pressurize the toner, a fixing belt which may transport an image receiving material with adhering toner while in contact with the toner image receiving layer, and a cooling part which can cool the heated image receiving material while it is still adhering to the fixing belt.

By employing the electrophotographic image receiving sheet having the toner image receiving layer in the apparatus for electrophotography which comprises the fixing belt, the toner adhering to the toner image receiving layer is fixed precisely without spreading onto the image receiving material, and the molten toner is cooled and solidified, while adhering closely to the fixing belt. In this way, the toner may be received onto the electrophotographic image receiving sheet with completely embedded in the toner image receiving layer. Therefore, a glossy and smooth toner image may be obtained without an image discrepancy.

The electrophotographic image receiving sheet may be particularly suitable for forming an image by means of the oilless belt fixing apparatus, and the offset may be remarkably improved owing to the electrophotographic image receiving sheet. By the way, the electrophotographic image receiving sheet may be applied for the other image forming types.

For example, by employing the electrophotographic image receiving sheet, a full-color image may be easily formed while improving image quality and preventing cracks. A full-color image may be formed by means of an apparatus for electrophotography capable of forming full-color images. An ordinary apparatus for electrophotography includes an image receiving paper transporting part, latent image forming part, and developing part disposed in the vicinity of the latent image forming part.

As for another way to improve image quality still more, instead of the electrostatic transfer, bias roller transfer or in combination therewith, transferring based on adhesive transfer or heat assistance transfer is known in the art. Specific construction may be referred for example in JP-A No. 63-113576 and No. 05-341666. In particular, the heat assistance transfer type with an intermediate transfer belt is preferred. Also, it is preferred to provide a cooling device for the intermediate belt in the position of after toner transfer or in the latter half of the toner transfer to the electrophotographic image receiving sheet. Due to this cooling device, the toner (toner image) is cooled to the softening point of the binder resin or lower, or the glass transition temperature of the toner or less, hence the image is efficiently transferred to the electrophotographic image receiving sheet and may be separated away from the intermediate transfer belt.

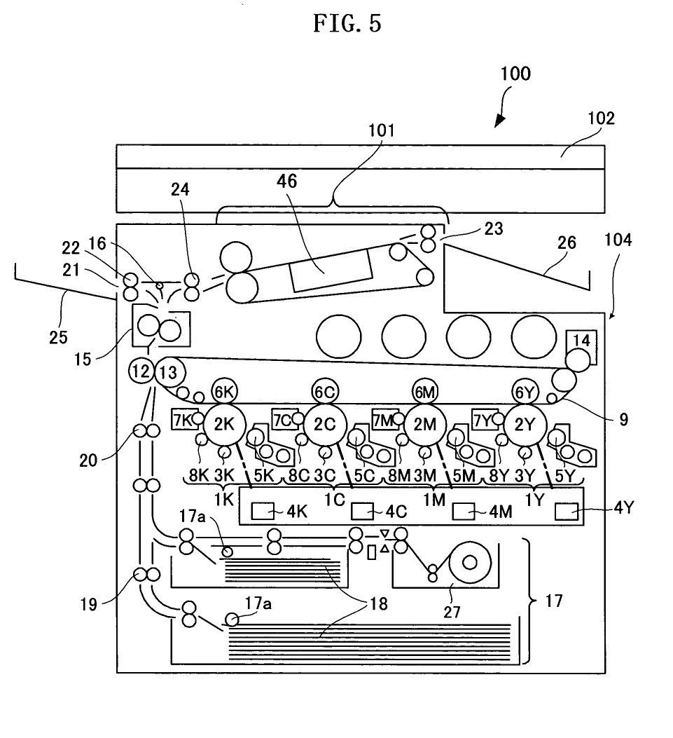

FIG. 5 is a schematic diagram of an image forming apparatus (color copying machine). The copying machine 100 comprises main body 104 and image reader (document reading unit) 102. The main body 104 contains an image output part (image-forming section) and image-fixing device 101.

The image forming part comprises an intermediate transfer belt 9 of endless type which is spanned over plural tension rollers and is rotated, electrophotographic image forming units 1Y to 1K, arranged from upstream to downstream of a rotation direction of the intermediate transfer belt 9 in order to form yellow, magenta, cyan, and black color toner images, respectively, belt cleaner 14 facing the intermediate transfer belt 9, secondary image transfer roller 12 facing the intermediate transfer belt 9, sheet tray 17 for housing image receiving sheets, pickup roller 17a, a pair of conveyer rollers 19 and 24, a pair of resist rollers 20, and output tray 26.

Each of the electrophotographic image forming units 1Y to 1k comprises photoconductive drum 2, electrostatic charger roller 3, development device 5, primary image transfer roller 6, drum cleaner 7, charge eliminating roller 8 and the like.

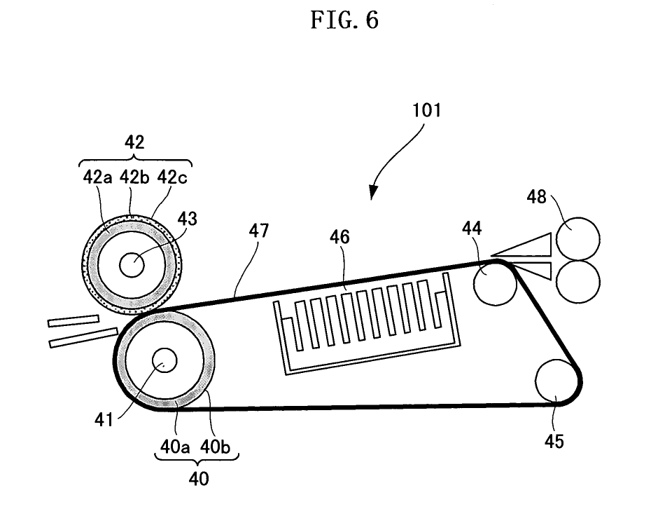

FIG. 6 schematically shows an exemplary unit 101 for smoothening and fixing a toner image equipped in the image forming apparatus. The unit 101 comprises heating and fixing roller 40 (heating roller) equipped with a heat source, releasing roller (tension roller) 44, steering roller (tension roller) 45, fixing belt (endless belt) 47 spanned over the heating and fixing roller 40 and releasing roller 44 and the steering roller 45, pressure roller 42 which presses heating and fixing roller 40 via fixing belt 47 to form a nip, and cooler (cooling unit) 46 which cools fixing belt 47 at the downstream of the nip in the rotation direction of the fixing belt 47.

In the unit 101 for smoothening and fixing a toner image, the electrophotographic image receiving sheet 18 that bears a toner is conveyed to the nip so as to bring the toner image into contact with the fixing belt 47, and the toner image is heated and fixed therein; following the fixing belt 47 and the electrophotographic image receiving sheet 18 are cooled, the electrophotographic image receiving sheet 18 is released (peeled off) from the fixing belt 47.

In the heating and fixing roller 40, releasing layer 40b formed of a fluorocarbon resin layer such as PFA tube is formed on the surface of core 40a made of metal having a high thermal conductivity. Heat source 41 such as halogen lamp is arranged inside core 40a and serves to heat the heating and fixing roller 40 to a predetermined surface temperature to thereby heat fixing belt 47 and image receiving sheet 18 bearing the toner image.

In the pressure roller 42, elastic layer 42b, made of for example silicone rubber having a rubber hardness (JIS-A) of about 40 degrees, is coated around core 42a made of a metal having high thermal conductivity; and also releasing layer 42c made of a fluorocarbon resin layer such as a PFA tube is coated on the surface of elastic layer 42b.

Heat source 43 such as halogen lamp is arranged inside the core 42a and serves to heat the pressure roller 42 to a predetermined surface temperature. The pressure roller 42 thus serves to apply pressure to the electrophotographic image receiving sheet 18 during image-fixing procedure and to heat the electrophotographic image receiving sheet 18 from its backside.

The configurations of the heating and fixing roller 40 and the pressure roller 42 are not limited to those mentioned above, as long as a toner image formed on the electrophotographic image receiving sheet 18 may be fixed to the electrophotographic image receiving sheet 18 by the aid of the fixing belt 47.

The releasing roller 44 serves to remove the electrophotographic image receiving sheet 18 from the fixing belt 47 by action of the rigidity of the electrophotographic image receiving sheet 18 itself. The outer shape (outer dimensions) of the releasing roller 44 is determined depending on the adhesion between the fixing belt 47 and the electrophotographic image receiving sheet 18, and the winding angle of the fixing belt 47 to the releasing roller 44.

The steering roller 45 serves to correct and regulate any wandering of the fixing belt 47 caused by rotation of the fixing belt 47 and to avoid damage of the edge of the belt due to wandering. This steering roller 45 is supported at one axial end thereof and may be tilted to a desired angle with respect to the heating and fixing roller 40. Thus, if the fixing belt 47 wanders, the steering roller serves to change the direction of the belt travel to an opposite direction.

The cooling device 46 serves to cool the fixing belt 47 and the electrophotographic image receiving sheet 18 in intimate contact with the fixing belt 47 and is arranged on an inner radius of the fixing belt 47 downstream from the heating and fixing roller 40 and upstream from the releasing roller 44. The cooling device 46 is capable of cooling a transparent resin layer 18a and the toner image on the surface of the electrophotographic image receiving sheet 18 fused by action of the heating and fixing roller 40 and the pressure roller 42 and of solidifying the entire surface of the image smoothly along the surface of the fixing belt 47.

The fixing belt 47 may be prepared, for example, in the following manner. A silicone rubber primer DY39-115 (trade name, available from Dow Corning Toray Silicone Co., Ltd., Japan) is applied to an endless film made of a thermosetting polyimide and is air-dried for 30 minutes. The resulting article is dipped in a coating liquid comprising 100 parts by mass of a silicone rubber precursor DY35-796AB and 30 parts by mass of n-hexane to form a coated film, then is subjected to primary curing at 120° C. for 10 minutes, resulting in a silicone rubber layer 40 μm thick thereon.

The silicone rubber layer is then dipped in a coating liquid comprising 100 parts by mass of a fluorocarbon siloxane rubber precursor SIFEL 610 (trade name, available from Shin-Etsu Chemical Co., Ltd., Japan) and 20 parts by mass of a fluorine-containing solvent (a mixture of m-xylene hexafluoride, perfluoroalkanes, and perfluoro(2-butyltetrahydrofuran)) to form a coated film, is subjected to primary curing at 120° C. for 10 minutes and to secondary curing at 180° C. for 4 hours to yield a fluorocarbon siloxane rubber layer 20 μm thick thereon and thereby yields the fixing belt.

The unit 101 for smoothing and fixing a toner image is arranged below the image reader 102 and above the image forming section (e.g., at image transfer position). The unit 101 is positioned directly above the image forming part (e.g., the intermediate image transfer belt 9) and directly under the image reader 102. The entire conveying path for the electrophotographic image receiving sheet 18 extending from the second image transfer position to the unit 101 is positioned directly above the image forming part (e.g., the intermediate image transfer belt 9). The normal component of the primary image-fixing line connecting between the secondary image transfer position and the primary image transfer position extends substantially in vertical direction. Further, the normal component of the image-fixing line connecting between the secondary image transfer position and the image-fixing position is less than the horizontal component of the image-fixing line. In addition, electrophotographic image receiving sheet 18 discharged from the unit 101 is ejected to the space directly above the image forming section (e.g., the intermediate image transfer belt 9).

<Electrophotographic Image Receiving Sheet>

The electrophotographic image receiving sheet may be properly selected without particular limitations, provided that the sheet comprises a toner-receiving layer containing a thermoplastic resin on a support.

The electrophotographic image receiving sheet comprises a support, and a toner-receiving layer on at least one surface of the support, and the other layers properly selected depending on the necessities such as a protection layer, intermediate layer, underlayer, cushion layer, static control (prevention) layer, reflecting layer, color tone adjusting layer, storage property improvement layer, antistick layer, anticurl layer, smoothing layer and the like. These layers may have a single-layer structure or a laminated structure.

[Support]

The support may be properly selected without particular limitations; examples of the support include raw paper, synthetic paper, synthetic resin sheet, coated paper, laminated paper, and the like. These supports may be of single layer or laminated layers. Among theses, the laminated paper coated with polyolefin resin layer on both side of the raw paper is preferred with respect to smoothness, gloss and elastic properties.

Raw Paper

The raw paper may be a high quality paper, for example, the paper described in Shashin kogaku no kiso—ginen shashin hen [Basic Photography Engineering—Silver Halide Photography], CORONA PUBLISHING CO., LTD. (1979) pp. 223-224, edited by the Institute of Photography of Japan.

In the raw paper, it is preferred to use pulp fibers having a fiber length distribution as disclosed, for example, in JP-A No. 58-68037 (e.g., the sum of 24 mesh on and 42 mesh on is 20 to 45% by mass, and 24 mesh on is 5% by mass or less) in order to give the desired center line average roughness to the surface. Moreover, the center line average roughness may be adjusted by heating and giving a pressure to a surface of the raw paper, with a machine calender, super calender and the like.

The raw paper may be properly selected without particular limitations, provided that they are known materials for support. Examples of the raw paper material include natural pulp of needle-leaf tree or broad-leaf tree, mixture of natural pulp and synthetic pulp and the like.

As for the pulp available for the raw paper, broadleaf tree bleached kraft pulp (LBKP) is preferred from the viewpoint of good balance between surface flatness and smoothness of the raw paper, rigidity and dimensional stability (curl). Needle-leaf bleached kraft pulp (NBKP), broadleaf tree sulfite pulp (LBSP) and the like may also be available.

A beater or refiner and the like may be employed for beating the pulp.

The Canadian Standard Freeness of the pulp is preferably 200 to 440 ml CSF, and more preferably 250 to 380 ml CSF, to control contraction of paper during the treatment.

Various additives, for example, filler, dry paper reinforcer, sizing agent, wet paper reinforcer, fixing agent, pH regulator or other agents and the like may be added, if necessary, to the pulp slurry (hereafter, referred to “pulp paper material”) which is obtained after beating the pulp.

Examples of the filler include calcium carbonate, clay, kaolin, white clay, talc, titanium oxide, diatomaceous earth, barium sulfate, aluminum hydroxide, magnesium hydroxide and the like.

Examples of the dry paper reinforcer include cationic starch, cationic polyacrylamide, anionic polyacrylamide, amphoteric polyacrylamide, carboxy-modified polyvinyl alcohol and the like.

Examples of the sizing agent include aliphatic salts, rosin, derivatives of rosin such as maleic rosin and the like, paraffin wax, alkyl ketene dimer, alkenyl succinic anhydride (ASA), epoxy aliphatic amide, and the like.

Examples of the wet paper reinforcer include polyamine polyamide epichlorohydrin, melamine resin, urea resin, epoxy polyamide resin, and the like.

Examples of the fixing agent include polyfunctional metal salts such as aluminum sulfate, aluminum chloride, and the like; cationic polymers such as cationic starch, and the like.

Examples of the pH regulator include caustic soda, sodium carbonate, and the like.

Examples of other agents include defoaming agents, dyes, slime control agents, fluorescent whitening agents, and the like.

Moreover, softeners may also be added if necessary. For the softeners, ones which are disclosed on pp. 554-555 of Paper and Paper Treatment Manual (Shiyaku Time Co., Ltd.) (1980) and the like may be employed, for example.

These various additives may be used alone or in combination. The loadings of these additives may be properly selected; usually the loadings are preferably 0.1 to 1.0% by mass.

The pulp slurry or pulp paper material, to which the aforesaid various additives are compounded depending on the requirements, was formed into paper by means of paper machine such as hand paper machine, Fortlinear paper machine, round mesh paper machine, twin wire machine, combination machine, and the like, followed by drying to prepare raw paper. In addition, sizing treatment on the surface may be provided at prior to or following the drying if necessary.

The treatment liquid used for sizing a surface may be properly selected without particular limitations. The treatment liquid may be compounded with such material as water-soluble polymers, waterproof materials, pigments, dyes, fluorescent whitening agents, and the like.

Examples of the water-soluble polymer include cationic starch, polyvinyl alcohol, carboxy-modified polyvinyl alcohol, carboxymethyl cellulose, hydroxyethyl cellulose, cellulose sulfate, gelatin, casein, sodium polyacrylate, styrene-maleic anhydride copolymer sodium salt, sodium polystyrene sulfonate, and the like.

Examples of the waterproof material include latex emulsions such as styrene-butadiene copolymer, ethylene-vinyl acetate copolymer, polyethylene, vinylidene chloride copolymer and the like; polyamide polyamine epichlorohydrin and the like.

Examples of the pigment include calcium carbonate, clay, kaolin, talc, barium sulfate, titanium oxide, and the like.

As for the aforesaid raw paper, in order to improve the rigidity and dimensional stability (curling), it is preferred that the ratio (Ea/Eb) of the longitudinal Young's modulus (Ea) and the lateral Young's modulus (Eb) is within the range of 1.5 to 2.0. When the ratio (Ea/Eb) is less than 1.5 or more than 2.0, the rigidity and curling of the image-recording material is likely to be inferior, and may interfere with paper during the conveying operation.

It has been found that, in general, the “stiffness” of the paper differs depending on the various manners in which the paper is beaten, and the elasticity (modulus) of paper produced by paper making process through beating operation may be employed as an important indication of the “stiffness” of the paper. The elastic modulus of the paper may be calculated from the following equation by using the relation of the density and the dynamic modulus which shows the physical properties of a viscoelastic object, and by measuring the velocity of sound propagation in the paper using an ultrasonic oscillator.
E=ρc²(1−n²)

wherein “E” represents dynamic modulus; “ρ” represents density; “c” represents the velocity of sound in paper; and “n” represents Poisson's ratio.

Since n=0.2 or so in a case of ordinary paper, there is not much difference in the calculation, even if the calculation is performed by the following equation:
E=ρc²

Accordingly, if the density of the paper and acoustic velocity may be measured, the elastic modulus may be easily calculated. In the above equation, when measuring acoustic velocity, various instruments known in the art may be available, such as Sonic Tester SST-110 (Nomura Shoji Co., Ltd.) and the like.

The thickness of the raw paper may be properly selected depending on the application, usually 30 to 500 μm is preferred, 50 to 300 μm is more preferred, and 100 to 250 μm is still more preferred. The basis weight of the raw paper may be properly selected depending on the application, for example, 50 to 250 g/m² is preferred, and 100 to 200 g/m² is more preferred.

Synthetic Paper

Synthetic paper is a kind of paper of which the main component is polymer fibers other than cellulose. Examples of the polymer fibers include polyolefin fibers such as polyethylene, polypropylene, and the like.

Synthetic Resin Sheet (Film)

The synthetic resin sheet may be a synthetic resin formed in the shape of a sheet (film). Examples thereof include polypropylene film, stretched polyethylene film, stretched polypropylene, polyester film, stretched polyester film, nylon film, and the like. Further, films made white by stretching, white films containing a white pigment, and the like may be available.

Coated Paper

The coated paper is one produced by coating various resins on at least one surface of substrate such as raw paper, and the coated amount differs depending on the application. Examples of the coated paper include art paper, cast coated paper, Yankee paper, and the like.

The resin coated on the surface of the raw paper may be properly selected without particular limitations, preferably is thermoplastic resin. Examples of the thermoplastic resin include (1) polyolefin resins, (2) polystyrene resins, (3) acryl resins, (4) polyvinyl acetate and derivatives thereof, (5) polyamide resins, (6) polyester resins, (7) polycarbonate resins, (8) polyether (polyacetal) resins, and (9) the other resins. These thermoplastic resins may be used alone or in combination.

The aforesaid (1) polyolefin resins include, for example, olefin resins such as polyethylene and polypropylene, and copolymers of olefin monomers such as ethylene or propylene and the other vinyl monomers. Examples of the copolymer resin of olefin monomer and the other vinyl monomer include ethylene-vinylacetate copolymer, ionomer resin which is copolymer of olefin monomer and acryl acid or methacrylic acid and the like. Further, the derivatives of polyolefin resin include chlorinated polyethylene, chlorosulfonated polyethylene and the like.

The aforesaid (2) polystyrene resins include, for example, polystyrene resin, styrene-isobutylene copolymer, acrylonitrile-styrene copolymer (AS resin), acrylonitrile-butadiene-styrene copolymer (ABS resin), polystyrene-maleicanhydride resin, and the like.

The aforesaid (3) acryl resins include, for example, polyacrylic acid, polyacrylate, polymethacrylic acid, polymethacrylate, polyacrylonitrile, polyacrylamide, and the like.

The esters of polyacrylic acid or polymethacrylic acid exhibit significantly various properties depending on the ester groups. Further, the (3) acryl resins include the copolymers with other monomers (e.g., acrylic acid, methacrylic acid, styrene, vinyl acetate etc.). The polyacrylonitrile is often utilized in copolymers as AS resin or ABS resin rather than a sole polymer.

The aforesaid (4) polyvinyl acetate and derivatives thereof include, for example, polyvinyl acetate, polyvinyl alcohol formed by partially saponify polyvinyl acetate, polyvinyl acetal resins formed by reacting polyvinyl alcohol with aldehyde (e.g., formaldehyde, acetaldehyde, butylaldehyde etc.).

The aforesaid (5) polyamide resins include polycondensation products of diamine and dibasic acid, for example, 6-nylon and 6,6-nylon.

The aforesaid (6) polyester resins include polycondensation products of alcohol and acid, and exhibits a wide variety of properties depending on the combination of the alcohol and acid. Conventional polyethylene terephthalate and polybutylene terephthalate formed from aromatic dibasic acid and divalent alcohol may be exemplified.

The aforesaid (7) polycarbonate resins typically include polycarbonate obtained from bisphenol A and phosgene.

The aforesaid (8) polyether (polyacetal) resins include, for example, polyether resins such as polyethylene oxide and polypropyleneoxide, and polyacetal resins such as polyoxymethylene obtained through ring-opening-polymerization.

The aforesaid (9) the other resins include polyurethane resins obtained through additional-polymerization and the like.

In addition, the thermoplastic resins may be incorporated with pigments or dyes such as brightener, conductive agent, filler, titanium oxide, ultramarine, carbon black, and the like depending on the application.

Laminated Paper

The laminated paper is one which is formed by laminating materials selected from various resins, rubbers, polymer sheets or films on substrate such as raw paper. Examples of the laminating material include polyolefin resins, polyvinyl chloride resins, polyester resins, polystyrene resins, polymethacrylate resins, polycarbonate resins, polyimide resins, triacetyl cellulose, and the like. These resins may be used alone or in combination.

The aforesaid polyolefin is often low-density polyethylene (LDPE); when the heat resistance should be enhanced, preferably, polypropylene, blend of polypropylene and polyethylene, high-density polyethylene (HDPE), blend of high-density polyethylene and low-density polyethylene and the like is utilized. From the viewpoint of cost and laminate applicability in particular, the blend of high-density polyethylene and low-density polyethylene is most preferable.

The blending ratio by mass of the high-density polyethylene and low-density polyethylene is preferably from 1:9 to 9:1, more preferably 2:8 to 8:2, and most preferably from 3:7 to 7:3. When thermoplastic resin layers are formed on both sides of the raw paper, preferably, the back side of the raw paper is formed of high-density polyethylene or a blend of high-density polyethylene and low-density polyethylene. The molecular weight of the polyethylene is not particularly limited, but it is preferable that melt indices of both high-density polyethylene and low-density polyethylene are 1.0 to 40 g/10-min and that the polyethylene exhibits a suitable extrusion property.

Further, these sheets or films may be applied a treatment so as to take a reflectivity against white color. Examples of such treatment include compounding a pigment such as titanium oxide or the like into the sheets or films.

The thickness of the support is preferably 25 to 300 μm, more preferably 50 to 260 μm, and still more preferably 75 to 220 μm. The rigidity of the support may vary depending on the application; preferably, the rigidity of the support utilized for the electrophotographic image receiving sheet of photographic image quality is similar to that of the support utilized for color silver halide photography.

Toner Image Receiving Layer

The aforesaid toner image receiving layer receives color and/or black toners and forms images. Specifically, the toner image receiving layer performs to receive a toner for forming images by means of a developing drum or an intermediate transferring body through static electricity and/or pressure in a transferring operation, and to fix images through heat and/or pressure in a fixing operation.

In these cases, preferably, a toner image receiving layer containing thermoplastic resin is disposed on at least one side of the support.

The toner image receiving layer contains at least a thermoplastic resin, and optionally various additives such as releasing agent, plasticizer, coloring agent, filler, cross-linker, antistat, emulsifier, dispersant and the like.

Thermoplastic Resin

The aforesaid thermoplastic resin may be properly selected depending on the application without particular limitations; examples of the thermoplastic resin include (1) polyolefin resins, (2) polystyrene resins, (3) acryl resins, (4) polyvinyl acetate resins and derivatives thereof, (5) polyamide resins, (6) polyester resins, (7) polycarbonate resins, (8) polyether (polyacetal) resins, and (9) the other resins. These thermoplastic resins may be used alone or in combination. Among these, polystyrene resins, acryl resins, and polyester resins having a high cohesive energy are properly employed considering the embedding effects on toners.

The aforesaid (1) polyolefin resins include, for example, olefin resins such as polyethylene and polypropylene, and copolymers of olefin monomers such as ethylene or propylene and the other vinyl monomers. Examples of the copolymer resin of olefin monomer and the other vinyl monomer include ethylene-vinyl acetate copolymer, ionomer resin which is copolymer of olefin monomer and acryl acid or methacrylic acid and the like. Further, the derivatives of polyolefin resin include chlorinated polyethylene, chlorosulfonated polyethylene and the like.

The aforesaid (2) polystyrene resins include, for example, polystyrene resin, styrene-isobutylene copolymer, acrylonitrile-styrene copolymer (AS resin), acrylonitrile-butadiene-styrene copolymer (ABS resin), polystyrene-maleic anhydride resin, and the like.

The aforesaid (3) acryl resins include, for example, polyacrylic acid, polyacrylate, polymethacrylic acid, polymethacrylate, polyacrylonitrile, polyacrylamide, and the like.

The polyacrylate includes homopolymer, bipolymer, terpolymer and the like of the acrylic ester (acrylate). Examples of the acrylic ester include methyl acrylate, ethyl acrylate, n-butyl acrylate, isobutyl acrylate, dodecyl acrylate, n-octyl acrylate, 2-ethylhexyl acrylate, 2-chlorethyl acrylate, phenyl acrylate, and α-chloromethyl acrylate.

The polymethacrylate includes homopolymer, bipolymer, terpolymer and the like of the methacrylic ester (methacrylate). Examples of the methacrylic ester include methyl methacrylate, butyl methacrylate.

The aforesaid (4) polyvinyl acetate and derivatives thereof include, for example, polyvinyl acetate, polyvinyl alcohol formed by partially saponify polyvinyl acetate, polyvinyl acetal resins formed by reacting polyvinyl alcohol with aldehyde (e.g., formaldehyde, acetaldehyde, butylaldehyde etc.).

The aforesaid (5) polyamide resins include polycondensation products of diamine and dibasic acid, for example, 6-nylon and 6,6-nylon.

The aforesaid (6) polyester resins may be produced by condensation polymerization of alcohol and acid ingredients. The acid ingredient may be properly selected depending on the application without particular limitations; examples of the acid include maleic acid, fumaric acid, citraconic acid, itaconic acid, glutaconic acid, phthalic acid, terephthalic acid, isophthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid, isooctylsuccinic acid, trimellitic acid, pyromellitic acid, anhydrides of these acids, lower alkyl ester of theses acids.

The aforesaid alcohol ingredient may be properly selected depending on the application without particular limitations, preferably is divalent alcohol such as diol. Examples of fatty diol include ethylene glycol, diethylene glycol, triethylene glycol, 1,2-propylene glycol, 1,3-propylene glycol, 1,4-butane diol, neopentyl glycol, 1,4-butene diol, 1,5-pentane diol, 1,6-hexane diol, 1,4-cyclohexane dimethanol, dipropylene glycol, polyethylene glycol, polypropylene glycol, polytetramethylene glycol. Further, addition products of alkyleneoxide to bisphenol A are available; examples of such product include, polyoxypropylene(2,2)-2,2-bis(4-hydroxyphenyl)propane, polyoxypropylene(3,3)-2,2-bis(4-hydroxyphenyl)propane, polyoxyethylene(2,0)-2,2-bis(4-hydroxyphenyl)propane, polyoxypropylene(2,0)-polyoxyethylene(2,0)-2,2-bis(4-hydroxy-phe nyl)propane, polyoxypropylene(6)-2,2-bis(4-hydroxyphenyl)propane.

The aforesaid (8) polyether (polyacetal) resins include, for example, polyether resins such as polyethylene oxide and polypropyleneoxide, and polyacetal resins such as polyoxymethylene obtained through ring-opening-polymerization.

The aforesaid (9) the other resins include polyurethane resins obtained through additional-polymerization.

The thermoplastic resin preferably satisfies the desired toner image receiving layer properties, which will be described later, when formed into a toner image receiving layer, and more preferably satisfies the desired properties by alone. These thermoplastic resins may be used alone or in combination.

The thermoplastic resin preferably has a molecular weight larger than that of a thermoplastic resin used in the toner. However, depending on the relationship of the thermodynamic properties of the thermoplastic resin used in the toner and the properties of the resin used in the toner image receiving layer, the relationship of the molecular weights as described above is not always preferable. For example, when a softening temperature of the resin used in the toner image receiving layer is higher than that of the thermoplastic resin used in the toner, in some cases, the molecular weight of the resin used in the toner image receiving layer is preferably the same or smaller than that of used in the toner.

It is also preferred that the thermoplastic resin is a mixture of resins having an identical composition and having different average molecular weights. For example, the preferable relationship with respect to molecular weights of thermoplastic resins employed in a toner is disclosed in JP-A No. 08-334915.

Molecular weight distribution of the thermoplastic resin in the tone image receiving layer is preferably wider than that of the thermoplastic resin used in the toner.

It is preferred that the thermoplastic resin satisfies the physical properties disclosed in JP-A No. 05-127413, No. 08-194394, No. 08-334915, No. 08-334916, No. 09-171265, No. 10-221877, and the like.

As for the polymer that constitutes the thermoplastic resin in the tone image receiving layer, it is particularly preferable that the polymer is of an aqueous resin such as water-dispersible resin, water-soluble resin, or the like for the following reasons (1) and (2).

(1) Since no organic solvent is discharged in coating and drying processes, it may provide excellent environmental preservation and workability.

(2) Since releasing agents such as wax are often insoluble in a solvent at room temperature, prior to use in many cases, they are dispersed in a solvent (water or an organic solvent). Further, aqueous resins may be relatively stable and provide superior processing or working ability. Further, in the case of aqueous resins, the wax tends to bleed on the surface relatively easily during the process of coating and drying, therefore the effects of a releasing agent (offset resistance, adhesion resistance, and the like) are relatively apparent.

The aqueous resin is not particularly restricted with respect to the composition, bonding structure, molecular structure, molecular weight, molecular weight distribution, and configuration, provided that it is water-soluble or water-dispersible. Examples of the aqueous substituent group include sulfonic acid group, hydroxy group, carboxylic acid group, amino group, amide group, ether group, and the like.

The water-dispersible polymer may be properly selected from the group consisting of the aqueous dispersions and emulsions of aforesaid resins (1) to (9) discussed earlier, copolymers of the constituent monomers of resins (1) to (9), cation denatured resins (1) to (9), mixtures thereof, and the like. These may be used alone or in combination.

The water-dispersible polymer may be synthesized or be available commercially. Examples of commercial product of the water-dispersible resin include, for polyester resins, Vylonal series by Toyobo Co., Ltd., Pesresin A series by Takamatsu Oil & Fat Co., Ltd., Tuftone UE series by Kao Corp., Polyester WR series by Nippon Synthetic Chemical Industry Co., Ltd., Eliel series by Unitika Ltd., and the like; and for acrylic resins, Hiros XE, KE, and PE series by Seiko Chemical Industries Co., Ltd., Jurymer ET series by Nippon Junyaku Co., Ltd., and the like.

The water-dispersible emulsions may be properly selected depending on the application, provided that the volume-averaged particle size of the dispersed particles is 20 nm or more; examples of the water-dispersible emulsions include water-dispersible polyurethane emulsions, water-dispersible polyester emulsions, chloroprene emulsions, styrene-butadiene emulsions, nitrile-butadiene emulsions, butadiene emulsions, vinylchloride emulsions, vinylpyridine-styrene-butadiene emulsions, polybutene emulsions, polyethylene emulsions, vinylacetate emulsions, ethylene-vinylacetate emulsions, vinylidenechloride emulsions, methylmethacrylate-butadiene emulsions, and the like. Among these, water-dispersible polyester emulsions are particularly preferred.

Preferably, the water-dispersible polyester emulsion is self-dispersing aqueous polyester emulsion, specifically self-dispersing aqueous polyester emulsion containing a carboxylic group is preferred in particular. By the way, the self-dispersing aqueous polyester emulsion indicates the aqueous emulsion that may disperse into an aqueous solvent spontaneously. The self-dispersing aqueous polyester emulsion containing a carboxylic group indicates the aqueous emulsion, containing polyester resin, that bears a carboxylic group as a hydrophilic group, and may disperse into an aqueous solvent spontaneously.

As for the aforesaid water-dispersible polyester emulsion of self-dispersing type, the emulsions that satisfy the following properties (1) to (4) are preferred. Since the emulsions are of self-dispersing type which does not include a surfactant, the hygroscopicity may be maintained at lower level even in higher humidity conditions, the softening point may not be significantly lowered due to moisture, and the occurrences of offset during fixing or sticking of sheets in storage may be efficiently suppressed. Moreover, since they are aqueous, they provide superior stabilities on environment and processing. Further, since a polyester resin is employed which tends to assume a molecular structure with higher cohesion energy, the resin comes to a melting state of lower elasticity (lower viscosity) in fixing of electrophotography while the resin exhibiting a sufficiently high hardness in the storage environment, thereby a sufficiently high image quality may be attained in a condition that the toner is embedded in the toner image receiving layer.

(1) The number-average molecular weight (Mn) is preferably 5000 to 10000, and more preferably 5000 to 7000.

(2) The molecular weight distribution (Mw/Mn) (weight-average molecular weight/number-average molecular weight) is preferably 4 or less, and more preferably 3 or less.

(3) The glass transition temperature (Tg) is preferably 40 to 100° C., and more preferably 50 to 80° C.

(4) The volume-average particle size is preferably 20 to 200 nm, and more preferably 40 to 150 nm.

The content of aforesaid water-dispersible emulsion in the toner image receiving layer is preferably 10 to 90% by mass, and more preferably 10 to 70% by mass.

The water-soluble polymer may be properly selected depending on the application without particular limitations, provided that the weight-averaged molecular weight (Mw) is 400,000 or less. The water-soluble polymer may be suitably synthesized or commercially available, and polyvinyl alcohol, carboxy-modified polyvinyl alcohol, carboxymethylcellulose, hydroxyethylcellulose, cellulose sulfate, polyethylene oxide, gelatin, cationic starch, casein, sodium polyacrylate, styrene-maleic anhydride copolymer sodium salt, sodium polystyrene sulfonate, and the like may be exemplified. Among these, polyethylene oxide is preferable in particular.

Examples of commercial product of water-soluble polymer include water-soluble polyesters such as various Plascoat products by Goo Chemical Co., Ltd. and Finetex ES series by Dainippon Ink and Chemicals Inc.; aqueous acrylic resins such as Jurymer AT series by Nippon Junyaku Co., Ltd. and Finetex 6161 and K-96 by Dainippon Ink and Chemicals Inc.; Hiros NL-1189 and BH-997 by Seiko Chemical Industries Co., Ltd., and the like.

In addition, examples of the water-soluble resin are given on page 26 of Research Disclosure No. 17,643, page 651 of Research Disclosure No. 18,716, pp. 873-874 of Research Disclosure No. 307,105, and JP-A No. 64-13546.

The content of water-soluble polymer in the toner image receiving layer may be properly selected depending on the application, in general the content is preferably 0.5 to 2 g/m².

The thermoplastic resin may be used in combination with other polymer material; in such case the content of the thermoplastic resin is generally higher than the other polymer material.

The content of the thermoplastic resin in the toner image receiving layer is preferably 10% by mass or more, more preferably 30% by mass or more, still more preferably 50% by mass or more, particularly preferred is 50 to 90% by mass.

Releasing Agent

The releasing agent is compounded into the toner image receiving layer in order to prevent offset of the toner image receiving layer. The releasing agent available in the present invention may be properly selected from any kind of agents provided that it melts by heating to the fixing temperature, it precipitates at the surface of the toner image receiving layer and exists exclusively at the surface after being cooling, and also it forms a releasing agent layer on the surface of the toner image receiving layer after being cooled and solidified.

Examples of the releasing agent include silicone compounds, fluorine compounds, waxes, and matting agents.

The releasing agent may, for example, be a compound mentioned in “Properties and Applications of Wax (Revised)” by Saiwai Publishing, or in the Silicone Handbook published by THE NIKKAN KOGYO SHIMBUN. Also, the silicone compounds, fluorine compounds and waxes in the toners mentioned in Japanese Patent Application Publication (JP-B) No. 59-38581, JP-B No.04-32380; Japanese Patent (JP-B) No.2838498, and JP-B No.2949558; and Japanese Patent Application Laid-Open (JP-A) No.50-117433, JP-A No. 52-52640, No. 57-148755, No.61-62056, No.61-62057, No.61-118760, No.02-42451, No.03-41465, No.04-212175, No.04-214570, No.04-263267, No.05-34966, No.05-119514, No.06-59502, No.06-161150, No.06-175396, No.06-219040, No.06-230600, No.06-295093, No.07-36210, No.07-43940, No. 07-56387, No. 07-56390, No. 07-64335, No. 07-199681, No. 07-223362, No.07-287413, No.08-184992, No.08-227180, No.08-248671, No.08-248799, No.08-248801, No.08-278663, No.09-152739, No.09-160278, No.09-185181, No.09-319139, No.09-319143, No.10-20549, No.10-48889, No.10-198069, No.10-207116, No.11-2917, No.11-144969, No.11-65156, No.11-73049 and No.11-194542 may be used. These compounds may be used alone or in combination.

Examples of the silicone compound include non-modified silicone oils (specifically, dimethyl siloxane oil, methyl hydrogen silicone oil, phenyl methyl silicone oil, or commercial products such as KF-96, KF-96L, KF-96H, KF-99, KF-50, KF-54, KF-56, KF-965, KF-968, KF-994, KF-995 and HIVAC F4, F-5 from Shin-Etsu Chemical Co., Ltd.; SH200, SH203, SH490, SH510, SH550, SH710, SH704, SH705, SH7028A, SH7036, SM7060, SM7001, SM7706, SH7036, SH8710, SH1107 and SH8627 from Dow Corning Toray Silicone Co., Ltd.; and TSF400, TSF401, TSF404, TSF405, TSF431, TSF433, TSF434, TSF437, TSF450 series, TSF451 series, TSF456, TSF458 series, TSF483, TSF484, TSF4045, TSF4300, TSF4600, YF33 series, YF-3057, YF-3800, YF-3802, YF-3804, YF-3807, YF-3897, XF-3905, XS69-A1753, TEX100, TEX101, TEX102, TEX103, TEX104, TSW831, and the like from GE Toshiba Silicones), amino-modified silicone oils (e.g., KF-857, KF-858, KF-859, KF-861, KF-864 and KF-880 from Shin-Etsu Chemical Co., Ltd., SF8417 and SM8709 from Dow Corning Toray Silicone Co., Ltd., and TSF4700, TSF4701, TSF4702, TSF4703, TSF4704, TSF4705, TSF4706, TEX150, TEX151 and TEX154 from GE Toshiba Silicones), carboxy-modified silicone oils (e.g., BY16-880 from Dow Corning Toray Silicone Co., Ltd., TSF4770 and XF42-A9248 from GE Toshiba Silicones), carbinol-modified silicone oils (e.g., XF42-B0970 from GE Toshiba Silicones), vinyl-modified silicone oils (e.g., XF40-A1987 from GE Toshiba Silicones), epoxy-modified silicone oils (e.g., SF8411 and SF8413 from Dow Corning Toray Silicone Co., Ltd.; TSF3965, TSF4730, TSF4732, XF42-A4439, XF42-A4438, XF42-A5041, XC96-A4462, XC96-A4463, XC96-A4464 and TEX170 from GE Toshiba Silicones), polyether-modified silicone oils (e.g., KF-351 (A), KF-352 (A), KF-353 (A), KF-354 (A), KF-355 (A), KF-615(A), KF-618 and KF-945 (A) from Shin-Etsu Chemical Co., Ltd.; SH3746, SH3771, SF8421, SF8419, SH8400 and SF8410 from Dow Corning Toray Silicone Co., Ltd.; TSF4440, TSF4441, TSF4445, TSF4446, TSF4450, TSF4452, TSF4453 and TSF4460 from GE Toshiba Silicones), silanol-modified silicone oils, methacryl-modified silicone oil, mercapto-modified silicone oil, alcohol-modified silicone oil (e.g., SF8427 and SF8428 from Dow Corning Toray Silicone Co., Ltd., TSF4750, TSF4751 and XF42-B0970 from GE Toshiba Silicones), alkyl-modified silicone oils (e.g., SF8416 from Dow Corning Toray Silicone Co., Ltd., TSF410, TSF411, TSF4420, TSF4421, TSF4422, TSF4450, XF42-334, XF42-A3160 and XF42-A3161 from GE Toshiba Silicones), fluorine-modified silicone oils (e.g., FS1265 from Dow Corning Toray Silicone Co., Ltd., and FQF501 from GE Toshiba Silicones), silicone rubbers and silicone fine particles (e.g., SH851U, SH745U, SH55UA, SE4705U, SH502 UA&B, SRX539U, SE6770 U-P, DY38-038, DY38-047, Torayfil F-201, F-202, F-250, R-900, R-902A, E-500, E-600, E-601, E-506, BY29-119 from Dow Corning Toray Silicone Co., Ltd.; Tospearl 105, Tospearl 120, Tospearl 130, Tospearl 145, Tospearl 240 and Tospearl 3120 from GE Toshiba Silicones), silicone-modified resins (specifically, olefin resins, polyester resins, vinyl resins, polyamide resins, cellulosic resins, phenoxy resins, vinyl chloride-vinyl acetate resins, urethane resins, acrylic resins, styrene-acrylic resins, compounds in which copolymerization resins thereof are modified by silicone, and the like), and the like. Examples of the commercial products include Daiallomer SP203V, SP712, SP2105 and SP3023 from Dainichiseika Color & Chemicals Mfg. Co., Ltd.; Modiper FS700, FS710, FS720, FS730 and FS770 from NOF Corp.; Symac US-270, US-350, US352, US-380, US-413, US-450, Reseda GP-705, GS-30, GF-150 and GF-300 from TOAGOSEI CO., LTD.; SH997, SR2114, SH2104, SR2115, SR2202, DCI-2577, SR2317, SE4001U, SRX625B, SRX643, SRX439U, SRX488U, SH804, SH840, SR2107 and SR2115 from Dow Corning Toray Silicone Co., Ltd., YR3370, TSR1122, TSR102, TSR108, TSR116, TSR117, TSR125A, TSR127B, TSR144, TSR180, TSR187, YR47, YR3187, YR3224, YR3232, YR3270, YR3286, YR3340, YR3365, TEX152, TEX153, TEX171 and TEX172 from GE Toshiba Silicones), and reactive silicone compounds (specifically, addition reaction type, peroxide-curing type and ultraviolet radiation curing type. Commercial examples thereof include: TSR1500, TSR1510, TSR1511, TSR1515, TSR1520, YR3286, YR3340, PSA6574, TPR6500, TPR6501, TPR6600, TPR6702, TPR6604, TPR6700, TPR6701, TPR6705, TPR6707, TPR6708, TPR6710, TPR6712, TPR6721, TPR6722, UV9300, UV9315, UV9425, UV9430, XS56-A2775, XS56-A2982, XS56-A3075, XS56-A3969, XS56-A5730, XS56-A8012, XS56-B1794, SL6100, SM3000, SM3030, SM3200 and YSR3022 from GE Toshiba Silicones), and the like.

Examples of the fluorine compound include fluorine oils (e.g., Daifluoryl #1, Daifluoryl # 3, Daifluoryl #10, Daifluoryl #20, Daifluoryl #50, Daifluoryl #100, Unidyne TG-440, TG-452, TG-490, TG-560, TG-561, TG-590, TG-652, TG-670U, TG-991, TG-999, TG-3010, TG-3020 and TG-3510 from Daikin Industries, Ltd.; MF-100, MF-110, MF-120, MF-130, MF-160 and MF-160E from Tohkem Products; S-111, S-112, S-113, S-121, S-131, S-132, S-141 and S-145 from Asahi Glass Co., Ltd.; and, FC-430 and FC-431 from DU PONT-MITSUI FLUOROCHEMICALS COMPANY, LTD.), fluoro rubbers (e.g., LS63U from Dow Corning Toray Silicone Co., Ltd.), fluorine-modified resins (e.g., Modepa F200, F220, F600, F220, F600, F2020, F3035 from Nippon Oils and Fats; Diaroma FF203 and FF204 from Dai Nichi Pure Chemicals; Saflon S-381, S-383, S-393, SC-101, SC-105, KH-40 and SA-100 from Asahi Glass Co., Ltd.; EF-351, EF-352, EF-801, EF-802, EF-601, TFE, TFEA, TFEMA and PDFOH from Tohkem Products; and THV-200P from Sumitomo 3M), fluorine sulfonic acid compound (e.g., EF-101, EF-102, EF-103, EF-104, EF-105, EF-112, EF-121, EF-122A, EF-122B, EF-122C, EF-123A, EF-123B, EF-125M, EF-132, EF-135M, EF-305, FBSA, KFBS and LFBS from Tohkem Products), fluorosulfonic acid, and fluorine acid compounds or salts (specifically, anhydrous fluoric acid, dilute fluoric acid, fluoroboric acid, zinc fluoroborate, nickel fluoroborate, tin fluoroborate, lead fluoroborate, copper fluoroborate, fluorosilicic acid, fluorinated potassium titanate, perfluorocaprylic acid, ammonium perfluorooctanoate, and the like), inorganic fluorides (specifically, aluminum fluoride, potassium fluoride, fluorinated potassium zirconate, fluorinated zinc tetrahydrate, calcium fluoride, lithium fluoride, barium fluoride, tin fluoride, potassium fluoride, acid potassium fluoride, magnesium fluoride, fluorinated titanic acid, fluorinated zirconic acid, ammonium hexafluorinated phosphoric acid, potassium hexafluorinated phosphoric acid, and the like).

Examples of the wax include synthetic hydrocarbon, modified wax, hydrogenated wax, natural wax, and the like.

Examples of the synthetic hydrocarbon include polyethylene wax (e.g., Polyron A, 393, and H-481 from Chukyo Yushi Co., Ltd.; Sunwax E-310, E-330, E-250P, LEL-250, LEL-800, LEL-400P, from SANYO KASEI Co., Ltd.), polypropylene wax (e.g., biscoal 330-P, 550-P, 660-P from SANYO KASEI Co., Ltd.), Fischer toropush wax (e.g., FT100, and FT-0070, from Nippon Seiro Co., Ltd.), an acid amide compound or an acid imide compound (specifically, stearic acid amide, anhydrous phthalic acid imide, or the like; e.g., Cellusol 920, B-495, hymicron G-270, G-110, hydrine D-757 from Chukyo Yushi Co., Ltd.), and the like.

Examples of the modified wax include amine-modified polypropylene (e.g., QN-7700 from SANYO KASEI Co., Ltd.), acrylic acid-modified wax, fluorine-modified wax, olefin-modified wax, urethane wax (e.g., NPS-6010, and HAD-5090 from Nippon Seiro Co., Ltd.), alcohol wax (e.g., NPS-9210, NPS-9215, OX-1949, XO-020T from Nippon Seiro Co., Ltd.), and the like.

Examples of the hydrogenated wax include cured castor oil (e.g., castor wax from Itoh Oil Chemicals Co., Ltd.), castor oil derivatives (e.g., dehydrated castor oil DCO, DCO Z-1, DCO Z-3, castor oil aliphatic acid CO-FA, ricinoleic acid, dehydrated castor oil aliphatic acid DCO-FA, dehydrated castor oil aliphatic acid epoxy ester D-4 ester, castor oil urethane acrylate CA-10, CA-20, CA-30, castor oil derivative MINERASOL S-74, S-80, S-203, S-42X, S-321, special castor oil condensation aliphatic acid MINERASOL RC-2, RC-17, RC-55, RC-335, special castor oil condensation aliphatic acid ester MINERASOL LB-601, LB-603, LB-604, LB-702, LB-703, #11 and L-164 from Itoh Oil Chemicals Co., Ltd.), stearic acid (e.g., 12-hydroxystearic acid from Itoh Oil Chemicals Co., Ltd.), lauric acid, myristic acid, palmitic acid, behenic acid, sebacic acid (e.g., sebacic acid from Itoh Oil Chemicals Co., Ltd.), undecylenic acid (e.g., undecylenic acid from Itoh Oil Chemicals Co., Ltd.), heptyl acids (heptyl acids from Itoh Oil Chemicals Co., Ltd.), maleic acid, high grade maleic oils (e.g., HIMALEIN DC-15, LN-10, LN-00-15, DF-20 and SF-20 from Itoh Oil Chemicals Co., Ltd.), blown oils (e.g., selbonol #10, #30, #60, R-40 and S-7 from Itoh Oil Chemicals Co., Ltd.), cyclopentadieneic oil (CP oil and CP oil-S from Itoh Oil Chemicals Co., Ltd., or the like), and the like.

The natural wax is preferably selected from vegetable waxes, animal waxes, mineral waxes, and petroleum waxes.

Examples of the vegetable wax include carnauba wax (e.g., EMUSTAR AR-0413 from Nippon Seiro Co., Ltd., and Cellusol 524 from Chukyo Yushi Co., Ltd.), castor oil (purified castor oil from Itoh Oil Chemicals Co., Ltd.), rapeseed oil, soybean oil, Japan tallow, cotton wax, rice wax, sugarcane wax, candellila wax, Japan wax, jojoba oil, and the like. Among these, a carnauba wax having a melting point of 70° C. to 95° C. is particularly preferable from viewpoints of providing an electrophotographic image receiving sheet which is excellent in anti-offset properties, adhesive resistance, paper transporting properties, gloss, is less likely to cause crack and splitting, and is capable of forming a high quality image.

Examples of the animal wax include lanolin, spermaceti, whale oil, wool wax, and the like.

Examples of the mineral wax include montan wax, montan ester wax, ozokerite, ceresin, and the like, aliphatic acid esters (Sansosizer-DOA, AN-800, DINA, DIDA, DOZ, DOS, TOTM, TITM, E-PS, nE-PS, E-PO, E-4030, E-6000, E-2000H, E-9000H, TCP, C-1100, and the like, from New Japan Chemical Co., Ltd.), and the like. Among these, a montan wax having a melting point of 70° C. to 95° C. is particularly preferable from viewpoints of providing an electrophotographic image receiving sheet which is excellent in anti-offset properties, adhesive resistance, paper transporting properties, gloss, is less likely to cause crack and splitting, and is capable of forming a high quality image.

Examples of the petroleum wax include paraffin wax (e.g., Paraffin wax 155, Paraffin wax 150, Paraffin wax 140, Paraffin wax 135, Paraffin wax 130, Paraffin wax 125, Paraffin wax 120, Paraffin wax 115, HNP-3, HNP-5, HNP-9, HNP-10, HNP-11, HNP-12, HNP-14G, SP-0160, SP-0145, SP-1040, SP-1035, SP-3040, SP-3035, NPS-8070, NPS-L-70, OX-2151, OX-2251, EMUSTAR-0384 and EMUSTAR-0136 from Nippon Oils and Fats Co., Ltd.; Cellosol 686, Cellosol 428, Cellosol 651-A, Cellosol A, H-803, B-460, E-172, E-866, K-133, hydrin D-337 and E-139 from Chukyo Yushi Co., Ltd.; 125° paraffin, 125° FD, 130° paraffin, 135° paraffin, 135° H, 140° paraffin, 140° N, 145° paraffin and paraffin wax M from Nippon Oil Corporation), or a microcrystalline wax (e.g., Hi-Mic-2095, Hi-Mic-3090, Hi-Mic-1080, Hi-Mic-1070, Hi-Mic-2065, Hi-Mic-1045, Hi-Mic-2045, EMUSTAR-0001 and EMUSTAR-042X from Nippon Oils and Fats Co., Ltd; Cellosol 967, M, from Chukyo Yushi Co., Ltd.; 155 Microwax and 180 Microwax from Nippon Oil Corporation), and petrolatum (e.g., OX-1749, OX-0450, OX-0650B, OX-0153, OX-261BN, OX-0851, OX-0550, OX-0750B, JP-1500, JP-056R and JP-011P from Nippon Oils and Fats Co., Ltd.), and the like.

A content of the natural wax in the toner image receiving layer (at surface) is preferably 0.1 to 4 g/m², and more preferably 0.2 to 2 g/m².

When the content is less than 0.1 g/m², the anti-offset properties and the adhesive resistance deteriorate. When the content is more than 4 g/m², the quality of the image may deteriorate because of the excessive amount of wax.

The melting point of the natural wax is preferably 70 to 95° C., and more preferably 75 to 90° C., from a viewpoint of anti-offset properties and paper conveying properties.

The matting agent may be selected from publicly known matting agents. Solid particles for use in the matting agents may be classified into inorganic particles (inorganic matting agents) and organic particles (organic matting agents).

Specifically, the inorganic matting agents may be oxides (e.g., silicon dioxide, titanium oxide, magnesium oxide, aluminum oxide), alkaline earth metal salts (e.g., barium sulfate, calcium carbonate, and magnesium sulfate), silver halides (e.g., silver chloride, and silver bromide), glass, and the like.

Examples of the inorganic matting agent may be found, for example, in West German Patent No. 2529321, U.K. Patent No. 760775, No. 1260772, and U.S. Pat. No. 1,201,905, No. 2,192,241, No. 3,053,662, No. 3,062,649, No. 3,257,206, No. 3,322,555, No. 3,353,958, No. 3,370,951, No. 3,411,907, No. 3,437,484, No. 3,523,022, No. 3,615,554, No. 3,635,714, No. 3,769,020, No. 4,021,245 and No. 4,029,504.

Materials of the organic matting agent include starch, cellulose ester (e.g., cellulose acetate propionate), cellulose ether (e.g., ethyl cellulose) and a synthetic resin. The synthetic resin is preferred to be insoluble or difficult to be solved. Examples of the synthetic resin insoluble or difficult to be solved, include polymethacrylicacid esters such as polyalkyl methacrylate, polyalkoxyalkyl methacrylate, polyglycidyl methacrylate, and polymeth acrylamide; polyvinyl esters such as polyvinyl acetate; polyacrylonitrile, polyolefins such as polyethylene; polystyrene, benzoguanamine resin, formaldehyde condensation polymer, epoxy resin, polyamide, polycarbonate, phenolic resin, polyvinyl carbazole, polyvinylidene chloride, and the like. Copolymers, which are combined the monomers contained in the above polymers, may also be used.

In the case of the copolymers, a small amount of hydrophilic repeated units may be included. Examples of monomer which forms a hydrophilic repeated unit include acrylic acid, methacrylic acid, α,β-unsaturated dicarboxylic acid, hydroxyalkyl methacrylate, sulfoalkyl methacrylate, styrene sulfonic acid, and the like.

Examples of the organic matting agents can be found, for example, in the U.K. Patent No. 1055713, the U.S. Pat. No. 1,939,213, No. 2,221,873, No. 2,268,662, No. 2,322,037, No. 2,376,005, No. 2,391,181, No. 2,701,245, No. 2,992,101, No. 3,079,257, No. 3,262,782, No. 3,443,946, No. 3,516,832, No. 3,539,344, No. 3,591,379, No. 3,754,924 and No. 3,767,448, and JP-A No. 49-106821, and No. 57-14835.

Also, two or more types of solid particles may be used in conjunction as a matting agent. The average particle size of the solid particles of the matting agent may suitably be, for example, 1 to 100 μm, and is more preferably 4 to 30 μm. The usage amount of the matting agent may suitably be 0.01 to 0.5 g/m², and is more preferably 0.02 to 0.3 g/m².

The releasing agents for use in the toner image receiving layer may alternatively be derivatives, oxides, purified products, and mixtures of the aforementioned substances. These may also have reactive substituentes.

The melting point (° C.) of the releasing agent is preferably 70 to 95° C., and more preferably 75 to 90° C., from the viewpoints of anti-offset properties and paper conveying properties.

The releasing agent is also preferably a water-dispersible releasing agent, from the viewpoint of compatibility when a water-dispersible thermoplastic resin is used as the thermoplastic resin in the toner image receiving layer.

The content of the releasing agent in the toner image receiving layer is preferably 0.1 to 10% by mass, more preferably 0.3 to 8.0% by mass, still more preferably 0.5 to 5.0% by mass.

Plasticizer

The plasticizers known in the art may be used without particular limitation. These plasticizers have the effect of adjusting the fluidity or softening of the toner image receiving layer in connection with heat and/or pressure at fixing the toner.

The plasticizer may be selected by referring to “Chemical Handbook,” (Chemical Institute of Japan, Maruzen), “Plasticizers—their Theory and Application,” (ed. Koichi Murai, Saiwai Shobo), “The Study of Plasticizers, Part 1” and “The Study of Plasticizers, Part 2” (Polymer Chemistry Association), or “Handbook of Rubber and Plastics Blending Agents” (ed. Rubber Digest Co.), or the like.

Examples of the plasticizer include phthalic esters, phosphate esters, aliphatic acid esters, abiethyne acid ester, abietic acid ester, sebacic acid esters, azelinic ester, benzoates, butylates, epoxy aliphatic acid esters, glycolic acid esters, propionic acid esters, trimellitic acid esters, citrates, sulfonates, carboxylates, succinic acid esters, maleates, fumaric acid esters, phthalic acid esters, stearic acid esters, and the like; amides (e.g., aliphatic acid amides and sulfoamides); ethers; alcohols; lactones; polyethyleneoxy; and the like (see, for example, JP-A No. 59-83154, No. 59-178451, No. 59-178453, No. 59-178454, No. 59-178455, No. 59-178457, No. 62-174754, No. 62-245253, No. 61-209444, No. 61-200538, No. 62-8145, No. 62-9348, No. 62-30247, No. 62-136646, and No. 02-235694, and the like). The plasticizers may be utilized mixing into a resin.

The plasticizers may be polymers having relatively low molecular weight. In this case, it is preferred that the molecular weight of the plasticizer is lower than the molecular weight of the binder resin to be plasticized. Preferably, plasticizers have a molecular weight of 15000 or less, or more preferably 5000 or less. When a polymer plasticizer is used as the plasticizer, the polymer plasticizer is substantially the same kind with the binder resin to be plasticized. For example, when the polyester resin is plasticized, polyester having a lower molecular weight is preferable as the plasticizer. Further, oligomers may also be used as plasticizers.

Apart from the compounds mentioned above, there are commercially products such as, for example, Adecasizer PN-170 and lo PN-1430 from Asahi Denka Co., Ltd.; PARAPLEX-G-25, G-30 and G-40 from C.P.Hall; and, rosin ester 8 L-JA, ester R-95, pentalin 4851, FK 115, 4820, 830, Ruizol 28-JA, Picolastic A75, Picotex LC and Cristalex 3085 from Rika Hercules, Inc, and the like.

The plasticizer may be optionally employed to relax some stress and distortion (physical distortions of elasticity and viscosity, and distortions of mass balance in molecules, binder main chains or pendant portions) which are induced when toners are embedded in the toner image receiving layer.

The plasticizer may be dispersed microscopically in the toner image receiving layer. The plasticizer may also be dispersed microscopically in a sea-island state, in the toner image receiving layer. The plasticizer may present in the toner image receiving layer in a state of sufficiently mixed with the other components such as binder or the like.

The content of plasticizer in the toner image receiving layer is preferably 0.001 to 90% by mass, more preferably 0.1 to 60% by mass, and still more preferably 1 to 40% by mass.

The plasticizer may be employed for the purpose of adjusting the slidability (improvement of transportability by reducing friction), improving the offset of fixing part (release of toner or layer from the fixing part), adjusting the curling balance, adjusting the electrification (formation of a toner electrostatic image), and the like.

Colorant

The colorant may be properly selected depending on the application; examples of colorant include fluorescent whitening agents, white pigments, colored pigments, dyes, and the like.

The fluorescent whitening agent has absorption in the near-ultraviolet region, and is a compound which emits fluorescence in the range of 400 to 500 nm. The various fluorescent whitening agent known in the art may be used without particular limitations. Examples of the fluorescent whitening agent include the compounds described in “The Chemistry of Synthetic Dyes” Volume V, Chapter 8 edited by K. VeenRataraman. Specific examples of the fluorescent whitening agent include stilbene compounds, coumarin compounds, biphenyl compounds, benzo-oxazoline compounds, naphthalimide compounds, pyrazoline compounds, carbostyryl compounds, and the like. Examples of the commercial fluorescent whitening agents include WHITEX PSN, PHR, HCS, PCS, and B from Sumitomo Chemicals, UVITEX-OB from Ciba-Geigy, Co., Ltd., and the like.

The white pigment may be properly selected from conventional pigments depending on the application without particular limitations, examples of the white pigments include the inorganic pigments such as titanium oxide, calcium carbonate, and the like.

The colored pigment may be properly selected from conventional pigments depending on the application without particular limitations, examples of the colored pigment include various pigments described in JP-A No. 63-44653, azo pigments, polycyclic pigment, condensed polycyclic pigment, lake pigment, carbon black and the like.

The azo pigments include azo lakes (e.g., carmine 6B, red 2B etc.), insoluble azo pigments (e.g., monoazo yellow, disazo yellow, pyrazolo orange, and Balkan orange etc.), and condensed azo pigments (e.g., chromophthal yellow, chromophthal red etc.).

The polycyclic pigments include phthalocyanines such as copper phthalocyanine blue and copper phthalocyanine green.

The condensed polycyclic pigments include dioxazine pigments such as dioxazine violet, isoindolinone pigments such as isoindolinone yellow, surene pigments, perylene pigments, perinon pigments, thioindigo pigments.

The lake pigments include malachite green, rhodamine B, rhodamine G, Victoria blue B and the like.

The inorganic pigments include oxides such as titanium dioxide and red iron oxide, sulfate such as precipitated barium sulfate, carbonate such as precipitated calcium carbonate, silicate such as hydrous silicate and anhydrous silicate, metal powder such as aluminum powder, bronze powder, zinc powder, chrome yellow, and iron blue.

These may be used alone or in combination.

The dyes may be properly selected from conventional dyes depending on the application without particular limitations; the dyes include anthraquinone compounds, azo compounds, and the like. These may be used alone or in combination.

As for the dyes of water-insoluble type, vat dyes, disperse dyes, oil-soluble dyes and the like are exemplified. The vat dyes include C.I.Vat violet 1, C.I.Vat violet 2, C.I.Vat violet 9, C.I.Vat violet 13, C.I.Vat violet 21, C.I.Vat blue 1, C.I.Vat blue 3, C.I.Vat blue 4, C.I.Vat blue 6, C.I.Vat blue 14, C.I.Vat blue 20 and C.I.Vat blue 35, and the like. The disperse dyes include C.I. disperse violet 1, C.I. disperse violet 4, C.I. disperse violet 10, C.I. disperse blue 3, C.I. disperse blue 7, C.I. disperse blue 58 and the like. The oil-soluble dyes include C. I. solvent violet 13, C.I. solvent violet 14, C.I. solvent violet 21, C.I. solvent violet 27, C.I. solvent blue 11, C.I. solvent blue 12, C.I. solvent blue 25, C.I. solvent blue 55, and the like.

Colored couplers used in silver halide photography may also be preferably used.

The content of the colorant in the toner image receiving layer is preferably 0.1 to 8 g/m², and more preferably 0.5 to 5 g/m².

When the content of colorant is less than 0.1 g/m², the light transmittance in the toner image receiving layer becomes high, when it is more than 8 g/m², the handling becomes more difficult, due to crack and adhesive resistance.

The filler may be an organic or inorganic filler; and reinforcing materials for binder resins, bulking agents and reinforcements known in the art may be utilized.

The filler may be selected referring to “Handbook of Rubber and Plastics Additives” (ed. Rubber Digest Co.), “Plastics Blending Agents—Basics and Applications” (New Edition) (Taisei Co.), “The Filler Handbook” (Taisei Co.), and the like.

In addition, as for the filler, various inorganic fillers or pigments may be employed. Examples of inorganic filler or pigment include silica, alumina, titanium dioxide, zinc oxide, zirconium oxide, micaceous iron oxide, white lead, lead oxide, cobalt oxide, strontium chromate, molybdenum pigments, smectite, magnesium oxide, calcium oxide, calcium carbonate, mullite, and the like. Among these, silica and alumina are particularly preferred. These fillers may be used alone or in combination. It is preferred that the filler is of relatively small particle size. If the particle size is relatively large, the surface of the toner image receiving layer is likely to be roughened.

The aforesaid silica include spherical silica and amorphous silica. The silica may be synthesized by the dry method, wet method or aerogel method. The surface of the hydrophobic silica particles may also be treated with trimethylsilyl groups or silicone. The silica is preferably colloidal silica, and the silica is preferably porous.

The aforesaid alumina includes anhydrous alumina and hydrated alumina. Examples of crystallized anhydrous alumina which may be available, are α, β, γ, δ, ζ, η, θ, κ, ρ, or χ. Hydrated aluminas are preferred to anhydrous aluminas. The hydrated aluminas may be monohydrate or trihydrate. Monohydrate aluminas include pseudo-boehmite, boehmite and diaspore. Trihydrate aluminas include gibbsite and bayerite. The alumina is preferably porous alumina.

The alumina hydrate may be synthesized by a sol-gel method, in which ammonia is added to an aluminum salt solution to precipitate alumina, or by hydrolysis of an alkali aluminate. Anhydrous alumina may be obtained by dehydrating alumina hydrate by heating.

The loadings of the filler is preferably 5 to 2000 parts by mass based on 100 parts by mass of the dried binder in the toner image receiving layer.

A crosslinking agent may be added in order to adjust the storage stability or thermoplastic properties of the toner image receiving layer. Examples of the crosslinking agent include compounds containing two or more reactive groups in the molecule, such as an epoxy group, isocyanate group, aldehyde group, active halogen group, active methylene group, acetylene group and other reactive groups known in the art.

In addition, the cross-linking agent may also be a compound having two or more groups capable of forming bonds such as hydrogen bonds, ionic bonds, stereochemical bonds, and the like.

The cross-linking agent may be a compound known in the art such as a coupling agent for resin, curing agent, polymerizing agent, polymerization promoter, coagulant, film-forming agent, film-forming assistant, and the like. Examples of the coupling agents include chlorosilanes, vinylsilanes, epoxysilanes, aminosilanes, alkoxyaluminum chelates, titanate coupling agents, and the like. The examples further include other agents known in the art such as those mentioned in Handbook of Rubber and Plastics Additives (ed. Rubber Digest Co.).

Preferably, a charge control agent is incorporated into the toner image receiving layer in order to adjust transfer and adhesion of toner, and prevent charge adhesion of a toner image receiving layer.

The charge control agent may be any charge control agent known in the art. Examples of the charge control agent include surfactants such as a cationic surfactant, an anionic surfactant, an amphoteric surfactant, a nonionic surfactant, or the like; polymer electrolytes, electroconducting metal oxides, and the like.

Examples of the surfactant include cationic charge inhibitors such as quaternary ammonium salts, polyamine derivatives, cation-modified polymethylmethacrylate, cation-modified polystyrene, or the like; anionic charge inhibitors such as alkyl phosphates, anionic polymers, or the like; and nonionic charge inhibitors such as aliphatic ester, polyethylene oxide, or the like.

When the toner has a negative charge, the cationic charge control agent and the nonionic charge control agent, compounded in the toner image receiving layer, are preferably cationic or anionic.

Examples of aforesaid electroconducting metal oxide include ZnO, TiO₂, SnO₂, Al₂O₃, In₂O₃, SiO₂, MgO, BaO, MoO₃, and the like. These may be used alone or in combination.

Moreover, the metal oxide may contain other elements (doping). For example, ZnO may contain Al, In, or the like; TiO₂ may contain Nb, Ta, or the like; and SnO₂ may contain (or, dope) Sb, Nb, halogen elements, or the like.

Other Additives

Various additives may also be compounded into the toner image receiving layer in order to improve the output image stability or to improve stability of the toner image receiving layer itself. Examples of the additives include antioxidants, age resistors, degradation inhibitors, anti-ozone degradation inhibitors, ultraviolet ray absorbers, metal complexes, light stabilizers, preservatives, fungicide, and the like.

Examples of the antioxidant include chroman compounds, coumarane compounds, phenol compounds (e.g., hindered phenols), hydroquinone derivatives, hindered amine derivatives, spiroindan compounds, and the like. The antioxidants may be found, for example, in JP-A No. 61-159644.

Examples of age resistor include those found in Handbook of Rubber and Plastics Additives, Second Edition (1993, Rubber Digest Co.), pp. 76-121

Examples of the ultraviolet ray absorbers include benzotriazo compounds (see U.S. Pat. No. 3,533,794), 4-thiazolidone compounds (see U.S. Pat. No. 3,352,681), benzophenone compounds (see JP-A No. 46-2784), ultraviolet ray absorbing polymers (see JP-A No. 62-260152).

Examples of the metal complex include those described in U.S. Pat. No. 4,241,155, No. 4,245,018, No. 4,254,195; and JP-A No. 61-88256, No. 62-174741, No. 63-199248, No. 01-75568, No. 01-74272, and the like.

Further, ultraviolet ray absorbers and light stabilizers, those found in Handbook of Rubber and Plastics Additives, Second Edition (1993, Rubber Digest Co.), pp. 122-137 may be available.

Additives for photography known in the art may also be included in the available material to obtain the toner image receiving layer as described above. Examples of the photographic additive may be found in the Journal of Research Disclosure (hereinafter, referred to “RD”) No. 17643 (December 1978), No. 18716 (November 1979) and No. 307105 (November 1989). The relevant sections are shown.

| Type of additive | RD17643 | RD18716 | RD307105 |
|---|---|---|---|
| 1. Whitener | p.24 | p.648 right column | p.868 |
| 2. Stabilizer | pp.24-25 | p.649 right column | pp.868-870 |
| 3. Light absorber | pp.25-26 | p.649 right column | pp.873 |
| (Ultraviolet ray | | | |
| absorber) | | | |
| 4. Colorant image | p.25 | p.650 right column | p.872 |
| stabilizer | | | |
| 5. Film hardener | p.26 | p.651 left column | p.874-875 |
| 6. Binder | p.26 | p.651 left column | p.873-874 |
| 7. Plasticizer, | p.27 | p.650 right column | p.876 |
| lubricant | | | |
| 8. Auxiliary | pp.26-27 | p.650 right column | pp.875-876 |
| application agent | | | |
| (Surfactant) | | | |
| 9. Antistatic agent | p.27 | p.650 right column | p.876-877 |
| 10. Matting agent | | | pp.878-879 |

The toner image receiving layer is formed by applying a coating solution which contains the polymer used for the toner image receiving layer with a wire coater or the like onto the support, and drying the coating solution. The film forming temperature of the aforesaid thermoplastic resin is no less than room temperature on the preservation prior to printing, and no more than 100° C. on fixing the toner particles.

The coated amount of the toner image receiving layer is preferably 1 to 20 g/m², more preferably 4 to 15 g/m², in terms of mass in dry state.

The thickness of the toner image receiving layer may be properly selected without particular limitations, for example, the thickness is preferably half or more, more preferably one to three times of the toner particle size, specifically, the thickness is preferably 1 to 50 μm, more preferably 1 to 30 μm, still more preferably 2 to 20 μm, in particular 5 to 15 μm.

Physical Properties of Toner Image Receiving Layer

The 180° peeling strength of the toner image receiving layer with the fixing member at the fixing temperature is preferably 0.1 N/25 mm or less, and more preferably 0.041 N/25 mm or less. The 180° separation strength can be measured based on the method described in JIS K6887 using the surface material of the fixing member.

It is preferred that the toner image receiving layer has a high degree of whiteness. This whiteness is measured by the method specified in JIS P 8123, and is preferably 85% or more. It is preferred that the spectral reflectance is 85% or more in the wavelength of 440 nm to 640 nm, and that the difference between the maximum spectral reflectance and minimum spectral reflectance in this wavelength is within 5%. Further, it is preferred that the spectral reflectance is 85% or more in the wavelength of 400 nm to 700 nm, and that the difference between the maximum spectral reflectance and the minimum spectral reflectance in the wavelength is within 5%.

Specifically, for the whiteness, the value of L* is preferably 80 or higher, more preferably 85 or higher, and still more preferably 90 or higher in a CIE 1976 (L*a*b*) color space. The color tint of the white color is preferably as neutral as possible. Regarding the color tint of the whiteness, the value of (a*)²+(b*)² is preferably 50 or less, more preferably 18 or less and still more preferably 5 or less in a (L*a*b*) space.

The toner image receiving layer preferably serves to provide higher gloss on forming images. The gross level is preferably 60 or more, more preferably 75 or more, still more preferably 90 or more as 45° gloss in the entire region from white without the toner to the black at maximum concentration.

By the way, the gloss level is preferably 110 or less, since the gloss over 110 tends to be perceived as metal gloss and is not suitable in image quality. The gloss level may be determined in accordance with JIS Z8741 for example.

It is preferred that the toner image receiving layer has a high smoothness. The arithmetic average roughness (Ra) is preferably 3 μm or less, more preferably 1 μm or less, and still more preferably 0.5 μm or less, over the whole range from white without the toner, to the black at maximum concentration.

Arithmetic average roughness may be measured in accordance with JIS B 0601, JIS B 0651, and JIS B 0652.

It is preferred that the toner image receiving layer has one of the following physical properties, more preferred that it has a plurality of the following physical properties, and most preferred that it has all of the following physical properties.

(1) Tₘ (Melting temperature) of the toner image receiving layer is 30° C. or more, and equal to or less than Tₘ+20° C. of the toner.

(2) The temperature at which the viscosity of the toner image receiving layer is 1×10⁵ cp is 40° C. or higher, and lower than the corresponding temperature for the toner.

(3) At a fixing temperature of the toner image receiving layer, the storage elasticity modulus (G′) is 1×10² Pa to 1×10 Pa, and the loss elasticity modulus (G″) is 1×10² Pa to 1×10⁵ Pa.

(4) The loss tangent (G″/G′), which is the ratio of the loss elasticity modulus (G″) and the storage elasticity modulus (G′) at a fixing temperature of the toner image receiving layer, is 0.01 to 10.

(5) The storage modulus (G′) at a fixing temperature of the toner image receiving layer is from −50 to +2500, relative to the storage modulus (G″) at a fixing temperature of the toner.

(6) The inclination angle on the toner image receiving layer of the molten toner is 50° or less, and particularly preferably 40° or less.

The toner image receiving layer preferably satisfies the physical properties described in JP-B No. 2788358, and JP-A No. 07-248637, No. 08-305067 and No. 10-239889.

The surface electrical resistance of the toner image receiving layer is preferably 1×10⁶ to 1×10¹⁵ Ω/cm² (at 25° C. and 65%RH). When the surface electrical resistance is less than 1×10⁶ Ω/cm², the toner amount of the transferred toner on the toner image receiving layer is possibly not sufficient, and the resulting toner image tends to exhibit a lower density, whereas over 1×10¹⁵ Ω/cm², excessive charge is induced more than necessary at the transferring period, as a result that the toner is not transferred sufficiently, the image density is lower, and dusts tends to attach on the electrophotographic image receiving layer due to static electricity during handling it. Further, miss feed, duplicated conveying, electric discharge trace, and miss transferring may be derived.

Incidentally, the surface electrical resistance may be determined in accordance with JIS K6911, i.e. the sample is allowed to stabilize its moisture in the ambient condition of 20° C. and 65% humidity for 8 hours or more, then the surface electrical resistance is measured after one minute of conducting period with 100 V of applied voltage, under the same ambient condition by means of R8340 (by Advantest K.K.).

[Other Layers]

Surface Protective Layer

A surface protective layer may be disposed on the surface of the toner image receiving layer to protect the surface of the electrophotographic image receiving sheet, to improve storage properties, to improve handling ability, to facilitate writing ability, to improve paper transporting properties within an equipment, to confer anti-offset properties, or the like. The surface protective layer may comprise one layer, or two or more layers. In the surface protective layer, various thermoplastic resins or thermosetting resins may be used as binders, and are preferably the same types of resins as those of the toner image receiving layer. However, the thermodynamic properties and electrostatic properties are not necessarily identical to those of the toner image receiving layer, and may be individually optimized.

The surface protective layer is preferably compounded the aforesaid matting agent. The surface protective layer may comprise the various additives described above which can be used for the toner image receiving layer. In particular, in addition to the aforesaid matting agent, a releasing agent may be incorporated.

From the viewpoint of fixing properties, it is preferred that the outermost surface layer of the electrophotographic image receiving sheet (which refers to, for example, the surface protective layer, if disposed) has good compatibility with the toner.

Specifically, it is preferred that the contact angle with the molten toner is, for example, from 0° to 40°.

Backing Layer

It is preferred that, in the electrophotographic image receiving sheet, a backing layer is disposed on the opposite surface to the surface on which the support is disposed, in order to confer a back surface output compatibility, and to improve a back surface output image quality, curling balance and paper conveying properties within the apparatus.

There is no particular limitation on the color of the backing layer. However, if the electrophotographic image receiving sheet according to the present invention is a double-sided output image receiving sheet where an image is formed also on the back surface, it is preferred that the backing layer is also white. It is preferred that the whiteness and spectral reflectance are 85% or more, for both of the top surface and the back surface.

To improve double-sided output compatibility, the backing layer may have an identical structure to that of the toner image receiving layer. The backing layer may comprise the various additives described hereintofore. Among these additives, matting agents and charge control agents are particularly suitable. The backing layer may be a single layer, or may have a laminated structure comprising two or more layers.

Further, if releasing oil is used for the fixing roller or the like, to prevent offset during fixing, the backing layer may have oil absorbing properties.

Contact Improving Layer

In the electrostatic image receiving sheet, it is preferred to dispose a contact improving layer in order to improve the contact between the support and the toner image receiving layer. The contact improving layer may contain the various additives described above. Among these, cross-linking agents are particularly preferred to be blended in the contact improving layer. Furthermore, to improve accepting properties to toner, it is preferred that the electrophotographic image receiving sheet further comprises a cushion layer between the contact improving layer and the toner image receiving layer.

Intermediate Layer

An intermediate layer may for example be disposed between the support and a contact improvement layer, between a contact improvement layer and a cushion layer, between a cushion layer and a toner image receiving layer, or between a toner image receiving layer and a storage property improvement layer. In the case of an electrophotographic image receiving sheet comprising a support, a toner image receiving layer and an intermediate layer, the intermediate layer may of course be disposed for example between the support and the toner image receiving layer.

The intermediate layer may be formed by preparing a coating liquid for intermediate layer and processing the coating liquid. Owing to preparing the coating liquid, the intermediate layer may be formed on the support in a relatively easy manner, and the polymer for the intermediate layer may be allowed to infiltrate in the direction of the thickness of the support.

The polymer for the intermediate layer is preferably adapted to employ as to the coating liquid. The polymer for the intermediate layer may be properly selected depending on the application, provided that the coating liquid may be prepared. For example, the aforesaid polymers for the toner image receiving layer and the similar polymers may be employed; among these, the water-soluble polymers and water-dispersible polymers are preferred, in particular, the self-dispersible aqueous polyester emulsions and water-dispersible acrylic resins may be suitably employed.

The polymer for the intermediate layer may be employed in combination with other polymer materials. In such case, the content of the polymer for the intermediate layer is usually higher than that of the other polymer materials.

The content of the polymer for the intermediate layer in the intermediate layer is preferably 20% by mass or more, more preferably 30 to 100% by mass based on the mass of the intermediate layer.

The polymer for the intermediate layer preferably satisfies the properties disclosed in JP-A No. 5-127413, No. 8-194394, No. 8-334915, No. 8-334916, No. 9-171265, No. 10-221877 and the like.

In addition, various ingredients aforesaid with respect to the toner image receiving layer may be optionally incorporated as long as the performances of the intermediate layer are not disturbed.

The thickness of the intermediate layer may be properly selected depending on the application; for example, the thickness is preferably 4 to 50 μm.

The thickness of the electrophotographic image receiving sheet may be properly selected depending on the application; for example, the thickness is preferably 50 to 550 μm, more preferably 100 to 350 μm.

<Toner>

In the electrophotographic image receiving sheet, the toner image receiving layer receives toners during printing or copying.

The toner contains at least a binder resin and a colorant, and also may contain releasing agents and other components, if necessary.

Binder Resin for Toner

Examples of the binder resin include vinyl monopolymer of: styrenes such as styrene, parachlorostyrene, or the like; vinyl esters such as vinyl naphthalene, vinyl chloride, vinyl bromide, vinyl fluoride, vinyl acetate, vinyl propioniate, vinyl benzoate, vinyl butyrate, or the like; methylene aliphatic carboxylates such as methyl acrylate, ethyl acrylate, n-butyl acrylate, isobutyl acrylate, dodecyl acrylate, n-octyl acrylate, 2-chloroethyl acrylate, phenyl acrylate, á-methyl chloroacrylate, methyl methacrylate, ethyl methacrylate, butyl acrylate, or the like; vinyl nitriles such as acryloniotrile, methacrylonitrile, acrylamide, or the like; vinyl ethers such as vinyl methyl ether, vinyl ethyl ether, vinyl isobutyl ether, or the like; N-vinyl compounds such as N-vinyl pyrrole, N-vinylcarbazole, N-vinyl indole, N-vinyl pyrrolidone, or the like; and vinyl carboxylic acids such as methacrylic acid, acrylic acid, cinnamic acid, or the like. These vinyl monomers may be used either alone, or copolymers thereof may be used. Further, various polyesters may be used, and various waxes may be used in combination.

Among these resins, it is preferable to use a resin of the same type as the resin used for the toner image receiving layer of the present invention.

Colorant for Toner

The colorants known in the art may be employed without particular limitations. Examples of the colorant include various pigments such as carbon black, chrome yellow, Hansa yellow, benzidine yellow, threne yellow, quinoline yellow, permanent orange GTR, pyrazolone orange, Balkan orange, watch young red, permanent red, brilliant carmin 3B, brilliant carmin 6B, dippon oil red, pyrazolone red, lithol red, rhodamine B lake, lake red C, rose bengal, aniline blue, ultramarine blue, chalco oil blue, methylene blue chloride, phthalocyanine blue, phthalocyanine green, malachite green oxalate, or the like. Various dyes may also be added such as acridine, xanthene, azo, benzoquinone, azine, anthraquinone, thioindigo, dioxadine, thiadine, azomethine, indigo, thioindigo, phthalocyanine, aniline black, polymethine, triphenylmethane, diphenylmethane, thiazine, thiazole, xanthene, or the like. These colorants may be used alone or in combination.

It is preferred that the content of the colorant is 2 to 8% by mass. When the content of colorant is 2% by mass or less, the coloration is likely to be insufficient; when it is 8% by mass or more, transparency is likely to be deteriorated.

Releasing Agent for Toner

The releasing agent may be in principle any of the wax known in the art. Polar waxes containing nitrogen such as highly crystalline polyethylene wax having relatively low molecular weight, Fischertropsch wax, amide wax, urethane wax, and the like are particularly effective. For polyethylene wax, it is particularly effective when the molecular weight is 1000 or less, and is more preferable when the molecular weight is 300 to 1000.

Since the compounds containing urethane bonds tend to stay in a solid state due to the strength of the cohesive force of the polar groups even if the molecular weight is lower, and since the melting point may be set higher in view of the molecular weight, such compounds are suitable in general. The preferred molecular weight is 300 to 1000. The raw materials may be selected from various combinations such as a diisocyane acid compound with a mono-alcohol, a monoisocyanic acid with a mono-alcohol, dialcohol with mono-isocyanic acid, tri-alcohol with a monoisocyanic acid, and a triisocyanic acid compound with mono-alcohol. However, in order to prevent the molecular weight from becoming too large, it is preferable to combine a compound having multiple functional groups with another compound having one functional group, and it is important that the amount of functional groups be equivalent.

Examples of the monoisocyanic acid compound include dodecyl isocyanate, phenyl isocyanate and derivatives thereof, naphthyl isocyanate, hexyl isocyanate, benzyl isocyanate, butyl isocyanate, allyl isocyanate, and the like.

Examples of the diisocyanic acid compounds include tolylene diisocyanate, 4′-diphenylmethane diisocyanate, toluene diisocyanate, 1,3-phenylene diisocyanate, hexamethylene diisocyanate, 4-methyl-m-phenylene diisocyanate, isophorone diisocyanate, and the like.

Examples of the mono-alcohol include ordinary alcohols such as methanol, ethanol, propanol, butanol, pentanol, hexanol, heptanol, and the like.

Examples of the di-alcohols include numerous glycols such as ethylene glycol, diethylene glycol, triethylene glycol, trimethylene glycol, or the like; and examples of the tri-alcohols include trimethylol propane, triethylol propane, trimethanolethane, and the like. The present invention is not necessarily limited these examples, however.

These urethane compounds may be compounded with the resin or the colorant through a kneading operation, similarly to the conventional releasing agent, and may be applied as a type of kneaded-crushed toner. Further, in a case of using an emulsion polymerization cohesion scorification toner, the urethane compounds may be dispersed in water together with an ionic surfactant, polymer acid or polymer electrolyte such as a polymer base, heated above the melting point, and converted to fine particles by applying an intense shear in a homogenizer or pressure discharge dispersion machine to manufacture a releasing agent particle dispersion of 1 μm or less, which may be used together with a resin particle dispersion, colorant dispersion, or the like.

Other Component of Toner

The toner of the present invention may also contain other components such as internal additives, charge control agents, inorganic particles, or the like. Examples of the internal additives include metals such as ferrite, magnetite, reduced iron, cobalt, nickel, manganese, or the like; and alloys or magnets such as compounds containing these metals.

Examples of the charge control agent include dyes such as quaternary ammonium salt, nigrosine compounds, dyes made from complexes of aluminum, iron and chromium, or triphenylmethane pigments. The charge control agent can be selected from the ordinary charge control agent. Materials which are difficult to become solved in water are preferred from the viewpoint of controlling ionic strength which affects cohesion and stability during melting, and the viewpoint of less waste water pollution.

The inorganic fine particles may be any of the external additives for toner surfaces generally used, such as silica, alumina, titania, calcium carbonate, magnesium carbonate, tricalcium phosphate, or the like. It is preferred to disperse these with an ionic surfactant, polymer acid or polymer base.

Surfactants may also be used for emulsion polymerization, seed polymerization, pigment dispersion, resin particle dispersion, releasing agent dispersion, cohesion or stabilization thereof. For example, it is effective to use, in combination, anionic surfactants such as sulfuric acid ester salts, sulfonic acid salts, phosphoric acid esters, soaps, or the like; cationic surfactants such as amine salts, quaternary ammonium salts, or the like; or non-ionic surfactants such as polyethylene glycols, alkylphenol ethylene oxide adducts, polybasic alcohols, or the like. These may generally be dispersed by a rotary shear homogenizer or a ball mill, sand mill, dyno mill, or the like, all of which contain the media.

The toner may also contain an external additive, if necessary. Examples of the external additive include inorganic powder, organic particles, and the like. Examples of the inorganic particles include SiO₂, TiO₂, Al₂O₃, CuO, ZnO, SnO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, MgSO₄, and the like. Examples of the organic particles include aliphatic acids, derivatives thereof, and the like, powdered metal salts thereof, and resin powders such as fluorine resin, polyethylene resin, acrylic resin, or the like. The average particle size of the powder may be, for example, 0.01 to 5 μm, and is more preferably 0.1 to 2 μm.

There is no particular limitation on the process of manufacturing the toner, but it is preferably manufactured by a process comprising the steps of (i) forming cohesive particles in a dispersion of resin particles to manufacture a cohesive particle dispersion, (ii) adding a fine particle dispersion to the cohesive particle dispersion so that the fine particles adhere to the cohesive particles, thus forming adhesion particles, and (iii) heating the adhesion particles which melt to form toner particles.

Physical Properties for Toner

It is preferred that the volume-average particle size of the toner of the present invention is from 0.5 to 10 μm.

If the volume-average particle size of the toner is excessively small, it may afford adverse effects on handling of the toner (supplementation, cleaning properties, fluidability, or the like), and the productivity of the particles may be deteriorated. On the other hand, if the volume-average particle size is excessively large, it may afford adverse effects on image quality and resolution, both of which lead to granulariness and transferring properties.

It is preferred that the toner of the present invention satisfies the aforesaid volume-average particle size range, and that the volume-average particle distribution index (GSDv) is 1.3 or less.

It is preferred that the ratio (GSDv/GSDn) of the volume-average polymer distribution index (GSDv) and the number-average particle distribution index (GSDn) is 0.95 or more.

It is preferred that the toner of the present invention satisfies the volume-average particle size range, and that the average value of the shape factor expressed by the following equation is 1.00 to 1.50.
Shape factor=(n×L²)/(4×S)

(wherein, “L” represents the length of the toner particle and “S” represents the projected area of the toner particle.)

If the toner satisfies the above-noted conditions, it has a desirable effect on image quality, and in particular, on granulariness and resolution. Also, there is less risk of dropout and blur accompanying with toner transferring, and less risk of adverse effect on handling properties, even if the average particle size is not small.

The storage elasticity modulus G′ (measured at an angular frequency of ×10 rad/sec) of the toner itself is 1×10² Pa to 1×10⁵ Pa at 150° C., which is suitable for improving image quality and preventing offset at a fixing step.

The present invention will be illustrated in more detailed with reference to examples given below, but these are not to be construed as limiting the present invention.

### EXAMPLE 1

Preparation of Support

A broadleaf kraft pulp (LBKP) was beaten to 300 ml (Canadian standard freeness, C.S.F.) by a disk refiner, and adjusted to a fiber length of 0.58 mm so as to prepare a pulp paper material. To the pulp paper material, 1.2% by mass of cationic starch, 0.5% by mass of alkyl ketene dimer (AKD), 0.3% by mass of anion polyacrylamide, 0.2% by mass of epoxidized fatty acid amide (EFA), and 0.3% by mass of Polyamide polyamine epichlorhydrin were added based on the mass of pulp.

Note: In the alkyl ketene dimer (AKD), the alkyl moiety is derived from fatty acids mainly containing behenic acid. In the epoxidized fatty acid amide (EFA), the fatty acid moiety is derived from fatty acids mainly containing behenic acid.

From the resulting pulp paper material, a raw paper of 150 g/m² was prepared by means of a Fortlinear paper machine. In addition, 1.0 g/m² of PVA (polyvinyl alcohol) and 0.8 g/m² of CaCl₂ were added on the way of drying in the Fortlinear paper machine by means of a size press device.

At the end of the paper preparation, the density was adjusted to 1.01 g/cm³ by means of a soft calender. The raw paper was conveyed in a condition that the side of the raw paper, on which the toner image receiving layer is to be provided, contacts with the metal roller. The surface temperature of the metal roller was 140° C. In the resulting raw paper, the whiteness level was 91%, the Oken type smoothness was 265 seconds, and the Stokigt sizing degree was 127 seconds.

The resulting raw paper strip was subjected to corona discharge at output power of 17 kW. Then, a single layer of polyethylene resin having a composition shown in Table 1 was extruded and laminated onto the back side of the raw paper at a temperature of discharged fused film of 320° C. and at a line speed of 250 m/minute using a cooling roll with a surface matte roughness of 10 μm, thereby a back side polyethylene resin layer of 22 μm thick was provided.

TABLE 2

| | | | Amount of additive |
|---|---|---|---|
| Composition | MFR (g/10 min) | Density (g/cm³) | (% by mass) |
| HDPE | 12 | 0.967 | 70 |
| LDPE | 3.5 | 0.923 | 30 |

Then, a single layer of a master batch mixture was extruded and laminated onto the front side of the raw paper, on which the toner image receiving layer is to be formed, at a line speed of 250 m/minute using a cooling roll with a surface matte roughness of 0.7 μm, thereby a front side polyethylene resin layer 29 μm thick was provided. The mixture of master batches had a final composition shown in Table 4, contained first master batch pellets containing the LDPE as in Table 2 and titanium dioxide (TiO₂) in a composition shown in Table 3, and second master batch pellets containing 5% by mass of ultramarine blue.

Then, the front side and the backside were exposed to corona discharge at a power of 18 kW and 12 kW, respectively, and a gelatin undercoat layer was formed on the front side to prepare a support.

TABLE 3

| Composition | Content (% by mass) |
|---|---|
| LDPE (ρ = 0.921 g/cm³) | 37.98 |
| Anatase titanium dioxide | 60 |
| Zinc stearate | 2 |
| Antioxidant | 0.02 |

TABLE 4

| Composition | Amount of additive (% by mass) |
|---|---|
| LDPE (ρ = 0.921 g/cm³) | 67.7 |
| Anatase titanium dioxide | 30 |
| Zinc stearate | 2 |
| Ultramarine | 0.3 |

Then, the coating liquid for the toner image receiving layer, containing an aqueous dispersion of a self-dispersible polyester resin, an aqueous dispersion of a camauba wax, a polyvinyl alcohol (PVA) dispersion of titanium dioxide, a polyethylene oxide having a molecular weight of about 100000, and an anionic surfactant as shown in Table 5, was coated by means of a bar coater on the support so as to result in the amount of application shown in Table 5. As the result, the toner image receiving layer was formed. The coating liquid had a viscosity of 70 mPa-s, a surface tension of 30 mN/m, and a pH of 7.8.

TABLE 5

| Composition | Amount of application (g/m²) |
|---|---|
| Polyester resin | 11.0 |
| Carnauba wax | 1.2 |
| Anatase titanium dioxide | 1.1 |
| PVA-205 | 0.15 |
| Polyethylene oxide | 2.9 |
| Anionic surfactant | 0.3 |

Then, image forming was carried out on the resulting electrophotographic image receiving sheet in the following condition, by means of an electrophotographic apparatus (image forming apparatus) which is a full color laser printer (DCC-400) by Fuji Xerox Co., Ltd. as shown in FIG. 5 whose fixing unit is modified to a belt-type fixing unit by applying an apparatus for smoothening and fixing shown in FIG. 6.

Belt

Support of belt: Polyimide (PI) film, width=32 cm
Thickness=80 μm

Material of the release layer of the belt: SIFEL (a fluorocarbon siloxane rubber made by vulcanizing SIFEL 610, a fluorocarbon siloxane rubber precursor, available from Shin-Etsu Chemical Co., Ltd.), Thickness=12 μm

Cooling Device

Cooling device: Heat sink length=120 mm

Transport Speed: 53 mm/sec

<Evaluation of Image Turbulence>

Image forming was carried out while altering the width of the peripheral margin, on which the toner image is not formed, from 0.5 mm to 15 mm, through variously adjusting the transferring timing and transferring width of the electrophotographic apparatus, to produce various electrophotographic prints.

As for the resulting electrophotographic prints, the level of the turbulence at the leading and back edges of the respective images was evaluated with reference to the following standard. The results are summarized in Table 6.

TABLE 6

| | Turbulence | Turbulence |
|---|---|---|
| Peripheral Margin | at Leading Edge | at Back Edge |
| 15 mm | C | A |
| 13 mm | B | A |
| 12 mm | A | A |
| 9 mm | A | A |
| 7 mm | A | A |
| 5 mm | A | A |
| 3 mm | A | A |
| 2 mm | A | A |
| 1.5 mm | B | B |
| 1 mm | C | C |
| 0.5 mm | D | D |

[Evaluation Standard]
A - No Image Turbulence
B - Slight Image Turbulence
C - Somewhat Image Turbulence
D - Significant Image Turbulence

Referring to the results shown in Table 6, it is realized that the width of the peripheral margin of 1.2 to 13 mm, in particular 2 to 12 mm may provide superior electrophotographic prints without the occurrences of turbulence at the leading and back edges. The image qualities of the resulting electrophotographic prints were unexceptionally of high gloss, and were of high level equivalent with those of silver halide photographic prints.

In accordance with the present invention, the problems in the art may be resolved, i.e. electrophotographic prints that do not bear peripheral blank as silver halide photographic prints, that do not smear the apparatus or electrophotographic image receiving sheet, and that do not bear image turbulence at periphery portion have not been easily and effectively produced.

1. An image forming process comprising forming a toner image on an electrophotographic image receiving sheet,
wherein the electrophotographic image receiving sheet comprises a support and a toner image receiving layer, the toner image receiving layer comprises a thermoplastic resin, and the toner image receiving layer is formed on at least one surface of the support, and
wherein in the electrophotographic image receiving sheet, a peripheral margin exists on which the toner image is not formed, and the width of the peripheral margin is 1.2 mm to 13 mm.

2. The image forming process according to claim 1, wherein the width of the peripheral margin is 2 to 12 mm.

3. The image forming process according to claim 1, wherein the width of the peripheral margin is substantially constant in both of length and width directions of the electrophotographic image receiving sheet.

4. The image forming process according to claim 1, wherein the width of the peripheral margin is different between the length direction and the width direction of the electrophotographic image receiving sheet.

5. The image forming process according to claim 1, wherein the width of the peripheral margin in the length direction (L1) and the width of the peripheral margin in the width direction (L2) represent a relation of L1>L2.

6. The image forming process according to claim 1, wherein the support comprises raw paper, and polyolefin resin layers coated on both sides of the raw paper.

7. The image forming process according to claim 1, wherein the electrophotographic image receiving sheet is wrapped on a core material to form a roll configuration.

8. The image forming process according to claim 1, wherein the image forming process further comprises cutting and removing the peripheral margin.

9. The image forming process according to claim 1, wherein the image forming process further comprises smoothening and fixing the surface of the toner image, following forming the toner image.

10. The image forming process according to claim 9, wherein smoothening and fixing the surface of the toner image is carried out through heating and pressing as well as cooling and peeling the toner image, by means of a smoothening and fixing unit that is equipped with a heating and pressing member, a belt member and a cooling device.

11. An image forming apparatus comprising:
an electrophotographic image receiving sheet, and a toner image forming unit,
wherein the electrophotographic image receiving sheet comprises a support and a toner image receiving layer, the toner image receiving layer comprises a thermoplastic resin, and the toner image receiving layer is formed on at least one surface of the support,
wherein the toner image forming unit performs to form a toner image on the electrophotographic image receiving sheet, and
wherein in the electrophotographic image receiving sheet, a peripheral margin exists on which the toner image is not formed, and the width of the peripheral margin is 1.2 mm to 13 mm.

12. The image forming apparatus according to claim 11, wherein the width of the peripheral margin is 2 to 12 mm.

13. The image forming apparatus according to claim 11, wherein the electrophotographic image receiving sheet is wrapped on a core material to form a roll configuration.

14. The image forming apparatus according to claim 11, wherein the image forming apparatus further comprises a cutting and removing unit that performs to cut and remove the peripheral margin.

15. The image forming apparatus according to claim 11, wherein the image forming apparatus further comprises a smoothening and fixing unit that performs to smoothen and fix the surface of the toner image, following forming the toner image.

16. The image forming apparatus according to claim 15, wherein the smoothening and fixing unit is comprised of a unit for smoothening and fixing a toner image that is equipped with a heating and pressing member, a belt member and a cooling device.

17. An electrophotographic print prepared by an image forming process, wherein the image forming process comprises forming a toner image on an electrophotographic image receiving sheet,
wherein the electrophotographic image receiving sheet comprises a support and a toner image receiving layer, the toner image receiving layer comprises a thermoplastic resin, and the toner image receiving layer is formed on at least one surface of the support, and
wherein in the electrophotographic image receiving sheet, a peripheral margin exists on which the toner image is not formed, and the width of the peripheral margin is 1.2 mm to 13 mm.

18. The electrophotographic print according to claim 17, wherein the toner image is formed on the entire surface of the electrophotographic print through cutting and removing the peripheral margin.
